(19) United States
(12) Patent Application Publication
(10) Pub. No.: US 2022/0006883 A1
(43) Pub. Date: Jan. 6, 2022

(54) SYSTEM, APPARATUS, AND METHOD FOR PACKET-BASED NETWORK TRANSPORT INCLUDING A UNIFIED ADAPTER LAYER

(71) Applicant: Intel Corporation, Santa Clara, CA (US)

(72) Inventors: Amit Srivastava, Folsom, CA (US); Matthew A. Schnoor, Hillsboro, OR (US); Rajesh Bhaskar, Bangalore (IN); Aruni P. Nelson, Folsom, CA (US); Enrico David Carrieri, Placerville, CA (US); Devon Worrell, Folsom, CA (US)

(21) Appl. No.: 17/476,618

(22) Filed: Sep. 16, 2021

(51) Int. Cl. H04L 29/06; H04L 12/40

(52) U.S. Cl. CPC H04L 69/18; H04L 2012/40273; H04L 12/40013

(57) ABSTRACT

In one embodiment, an apparatus includes a unified adapter layer and a first bus controller. The unified adapter layer is to receive a first host data packet packetized in accordance with a host protocol and directed to a first device and decode the first host data packet to generate first and second data elements based on the first host data packet, the first device associated with a first device protocol. The first bus controller is coupled to the unified adapter layer and is to be coupled to the first device via a first bus. The first bus controller is to packetize the first data element in accordance with the first device protocol to generate a first device data packet for transmission to the first device in accordance with the first device protocol via the first bus and adjust a bus controller parameter based in part on the second data element. Other embodiments are described and claimed.

### TECHNICAL FIELD

Embodiments related to packet-based network transport in computerized systems.

### BACKGROUND

MIPI Alliance, Inc. is in the process of defining Autonomous PHY (A-PHY) targeting industrial and autonomous applications. A-PHY is an asymmetric, industry standard, long-reach, serializer-deserializer (SerDes) physical layer interface for automotive applications. Such applications typically provide low power, low pin count, and a high-speed serial input/output interface for long reach cables. Long reach cables may, for example, extend fifteen meters in length. A-PHY is designed for a wide range of applications including, for example, sensors, audio, camera, video, future sensors, for the automotive market and supports multiple protocols such as, for example, I3C for sensors, I3S for future audio, CSI-2 for cameras, and DSI for displays.

Current MIPI Alliance, Inc. applications often use different discrete components or bridge chips to convert various protocols. In many cases, the conversion of protocols involves the use of two levels of external bridges that isolate two protocols and involve two discrete solutions. The use of two levels of external bridges may introduce inefficiencies where upstream and downstream speeds are different, one being high speed and other being low speed.

### BRIEF DESCRIPTION OF THE DRAWINGS

FIG. 1 is a block diagram representation of a system including an embodiment of a bridge.

FIG. 2 is a diagrammatic representation of functions performed by an embodiment of a bridge.

FIG. 3 is a block diagram representation of an example of an automotive packet-based network transport system including an embodiment of a unified adapter layer.

FIG. 4 is a block diagram representation of an example of A-PHY data packet format of a host data packet.

FIG. 5 is a flow chart representation of an example of a method of processing host data packets associated with a host protocol for transmission to a device associated with a device protocol using an embodiment of a bridge.

FIG. 6 is a flow chart representation of an example of a method of processing device packets associated with a device protocol for transmission to a host device associated with a host protocol using an embodiment of a bridge.

FIG. 7 is a block diagram representation of an example of a system including an embodiment of a A-PHY to camera system bridge.

FIG. 8 is a block diagram representation of an example of a system including an embodiment of a A-PHY to I3C bridge.

FIG. 9 is a block diagram representation of an example of a system including an embodiment of a A-PHY to I3C bridge.

FIG. 10 is a block diagram representation of an example of a system including an embodiment of a A-PHY to I3C bridge.

FIG. 11 is a block diagram of a system in accordance with an embodiment.

FIG. 12 is an embodiment of a fabric composed of point-to-point links that interconnect a set of components.

FIG. 13 is an embodiment of a system-on-chip design.

FIG. 14 is a block diagram of a system in accordance with an embodiment.

### DETAILED DESCRIPTION

When a host device generates host data packets in accordance with a host protocol that are directed to one or more devices having different device protocols, a bridge including a unified adapter layer is used to facilitate communications between the host device and the one or more devices. The unified adapter layer decodes each of the host data packets received from the host device to generate one or more data elements. Examples of data elements include, command data elements, payload data elements, and bus controller parameter settings. The data elements generated by the unified adapter layer are placed in a packet buffer. An example of a host protocol is the Autonomous PHY (A-PHY). In alternative embodiments, the host device may generate and transmit host data packets in accordance with other host protocols. Examples of device protocols include, but are not limited to, I3C for sensors, I3S for future audio, CSI-2 for cameras, DSI for displays, I2S, C-PHY, MPHY, and DPHY.

Each of the host data packets includes a header that includes an adaption type that defines the protocol associated with the device that the host data packet is directed to, a priority associated with that host data packet, and an ordering of the host data packet relative to other related host data packets. The unified adapter layer associates each of the data elements generated based on a specific host device packet with the device that the host data packet is directed to, the adaption type, the priority, and the ordering.

The bridge includes one or more bus controllers. Each bus controller is configured to communicate via a specific device protocol. Each bus controller is coupled to one or more of the devices that are configured to communicate in accordance with the specific device protocol. For example, a first bus controller configured to communicate in accordance with the I3C protocol may be coupled to one or more devices that are configured to communicate in accordance with the I3C protocol via a first bus and a second bus controller configured to communicate in accordance with the DSI protocol may be coupled to one or more devices that are configured to communicate in accordance with the DSI protocol via a second bus.

Each bus controller is configured to retrieve the data elements that are associated with a device coupled to that bus controller from the packet buffer. If the bus controller retrieves a data element that is a payload data element or a command data element, the bus controller packetizes the data element in accordance with the device protocol specific to that bus controller to generated a device data packet for transmission to the device. In some cases, the unified adapter layer may generate two or more data elements based on a host data packet where one of the data elements is a bus controller parameter setting and the other data elements are command data elements and/or payload data elements. The bus controller adjusts a bus controller parameter in accordance with the bus controller parameter setting prior to transmission of the device data packets based on the other data elements.

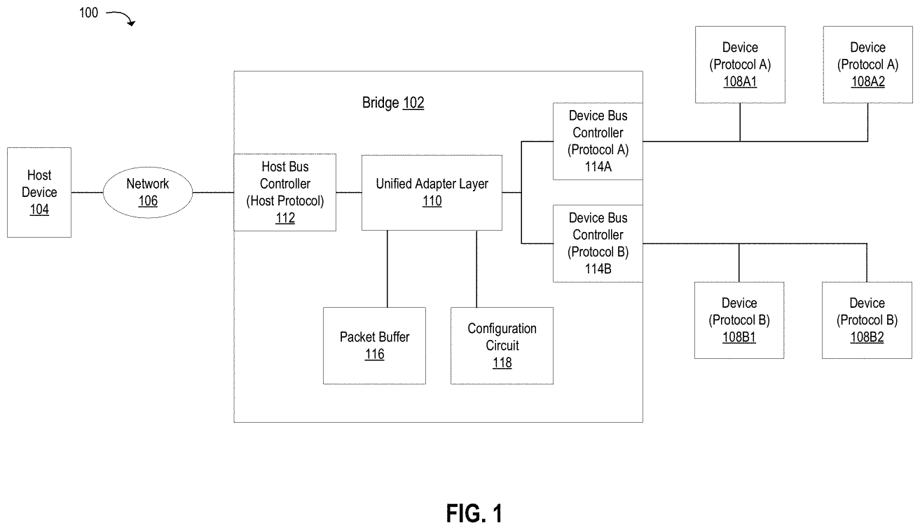

Referring to FIG. 1, a block diagram representation of a system 100 including an embodiment of a bridge 102 is shown. In an embodiment, the system 100 is a packet-based network transport system. In an embodiment, the system 100 is an automotive packet-based network transport system. The system 100 includes a host device 104 configured to be communicatively coupled to the bridge 102 via a network 106. The host device 104 is configured in accordance with a host protocol. In an embodiment, the host protocol is the A-PHY protocol. In an embodiment, the network 106 is an A-PHY network.

The bridge 102 is configured to be communicatively coupled to one more devices 108A1, 108A2 configured in accordance with a first device protocol Protocol A. In an embodiment, the bridge 102 is configured to be communicatively coupled to one more devices 108B1, 108B2 configured in accordance with a second device protocol Protocol B. While a bridge 102 configured to be communicatively coupled to multiple devices 108A1, 108A2, 108B1, 108B2 having two different protocols Protocol A, Protocol B is shown, alternative embodiments may include a bridge configured to be communicatively coupled to devices having a fewer or greater number of different device protocols. While a bridge 102 configured to be communicatively coupled to two devices 108A1, 108A2, 108B1, 108B2 associated with each device protocol Protocol A, Protocol B is shown, alternative embodiments may include a bridge 102 configured to be communicatively coupled to a fewer or greater number of devices associated with each of the different device protocols.

The bridge 102 includes a unified adapter layer 110, a host bus controller 112 and one or more device bus controllers 114A, 114B. The host bus controller 112 is configured to be communicatively coupled to the host device 104 via the network 106 and to the unified adapter layer 110. The host bus controller 112 is configured to process host data packets received from and transmitted to the host device 104 in accordance with the host protocol. In an embodiment, host bus controller 112 is configured to process host data packets received from and transmitted to the host device 104 in accordance with the A-PHY protocol.

The bridge 102 includes one or more device bus controllers 114A, 114B. The device bus controllers 114A, 114B are configured to be communicatively coupled to the unified adapter layer 110. Each device bus controller 114A, 114B is configured to process device data packets in accordance with a specific device protocol Protocol A, Protocol B and is configured to be communicatively coupled to one or more devices 108A1, 108A2, 108B1, 108B2 that are configured in accordance with that specific device protocol Protocol A, Protocol B. Each device bus controller 114A, 114B is configured to process device data packets received from and transmitted to the one or more devices 108A1, 108A2, 108B1, 108B2 that are communicatively coupled to that device bus controller 114A, 114B in accordance with the specific device protocol Protocol A, Protocol B.

The unified adapter layer 110 is configured to be communicatively coupled to the host bus controller 112 and the device bus controllers 114A, 114B. In an embodiment, the unified adapter layer 110 is configured to be communicatively coupled to a packet buffer 116. In an embodiment, the unified adapter layer 110 is configured to be communicatively coupled to a configuration circuit 118. In an embodiment, the configuration circuit 118 includes configuration data associated with each of the devices 108A1, 108A2, 108B1, 108B2. An example of configuration data is an operational status of each of the devices 108A1, 108A2, 108B1, 108B2. Examples of operational statuses include, but are not limited to, an on status, an off status, an idle status, an always on status, and an active status.

The unified adapter layer 110 is configured to receive host data packets packetized in accordance with the host protocol from the host bus controller 112. Each of the received host data packets are directed to one of the devices 108A1, 108A2, 108B1, 108B2. The unified adapter layer 110 decodes each of the received host data packets to generate one or more data elements based on each of the host data packets. Examples of data elements include, but are not limited to, a command data element, a payload data element, and a bus controller parameter setting. Examples of command data elements include, but are not limited to, a read command data element and a write command data element. Examples of bus controller parameter settings include, but are not limited to a clock speed of a device bus controller 114A, 114B, a slew rate of a device bus controller 114A, 114B, and a drive strength of a device bus controller 114A, 114B. The unified adapter layer 110 places each of the generated data elements in the packet buffer 116.

In an embodiment, the unified adapter layer 110 decodes each of the received host data packets to determine a priority associated with that host data packet. The unified adapter layer 110 associates the determined priority with each of the data elements generated based on that host data packet. The device bus controller 114A, 114B processes the data elements in accordance with the associated priority. In an embodiment, the unified adapter layer 110 decodes each of the received host data packets to determine a protocol Protocol A, Protocol B associated with the device 108A1, 108A2, 108B1, 108B2 that the host data packet is directed to. The unified adapter layer 110 places each of the data elements associated with each of the host data packets in the packet buffer 116 for processing by the device bus controller 114A, 114B associated with the determined protocol Protocol A, Protocol B.

In an embodiment, the unified adapter layer 110 decodes each of the received host data packets to determine an ordering of that host data packet with respect to other related host data packets. The unified adapter layer 110 associates the determined ordering with each of the data elements generated based on that host data packet. The device bus controller 114A, 114B processes the data elements in accordance with the associated ordering. In an embodiment, the unified adapter layer 110 implements error correction associated with received host data packets in accordance with error correction data included in each of the host data packets. In an embodiment, in the event an error is detected, an automatic retransmit of the one or more host data packets associated with the error is initiated.

In an embodiment, the unified adapter layer 110 determines the device 108A1, 108A2, 108B1, 108B2 that the host data packet is directed to based on the configuration data associated with each of the devices 108A1, 108A2, 108B1, 108B2 stored in the configuration circuit 118. In an embodiment, the host device 104 generate two or more related host data packets directed to a device 108A1, 108A2, 108B1, 108B2. In an embodiment, the unified adapter layer 110 waits until all of the related host data packets are received prior to generating the data elements associated with the related host data packets.

In an embodiment, each of the device bus controllers 114A, 114B is communicatively coupled to one of more devices 108A1, 108A2, 108B1, 108B2. For example, device bus controller 114A is communicatively coupled to devices 108A1, 108A2. The device bus controller 114A and the devices 108A1, 108A2 are configured in accordance with Protocol A. The device bus controller 114B is communicatively coupled to devices 108B1, 108B2. The device bus controller 114b and the devices 108B1, 108B2 are configured in accordance with Protocol B.

In an embodiment, the packet buffer 116 includes a buffer associated with each of the devices 108A1, 108A2, 108B1, 108B2. Each of the buffers includes data elements placed in that buffer by the unified adapter layer 110. Each of the device bus controllers 114A, 114B is configured to access the data elements in the buffers associated with the devices 108A1, 108A2, 108B1, 108B2 that are coupled to that device bus controller 114A, 114B. For example, device bus controller 114A is configured to access data elements in the buffers in the packet buffer 116 that are associated with devices 108A1, 108A2 and device bus controller 114B is configured to access data elements in the buffers in the packet buffer 116 that are associated with devices 108B1, 108B2. Each of the device bus controller 114A, 114B is configured to process the accessed data elements.

The unified adapter layer 110 is configured to decode device data packets that received from the devices 108A1, 108A2, 108B1, 108B2 at the device bus controllers 114A, 114B and packetized in accordance with the device protocol Protocol A, Protocol B. The unified adapter layer 110 is configured generate data elements based on the received device data packets and place the generated data elements in the packet buffer 116. The host bus controller 112 is configured to retrieve the data elements based on the device data packets from the packet buffer 116 and generate host data packets based on the retrieved data elements for transmission to the host device 104 via the network 106 in accordance with the host protocol. In an embodiment, an order in which data elements associated with the devices 108A1, 108A2, 108B1, 108B2 are processed by the host bus controller 112 may be based on an interrupt received from one of the devices 108A1, 108A2, 108B1, 108B2 at the bridge 102. When an interrupt is received from a device 108A1, 108A2, 108B1, 108B2, the host bus controller 112 prioritizes the processing of the data elements based on device data packets received from that device 108A1, 108A2, 108B1, 108B2 over those based on device data packets received from the other devices 108A1, 108A2, 108B1, 108B2

While a number of different components of the bridge 102 have been described, alternative embodiments of the bridge 102 may include additional components that facilitate operation of the bridge 102.

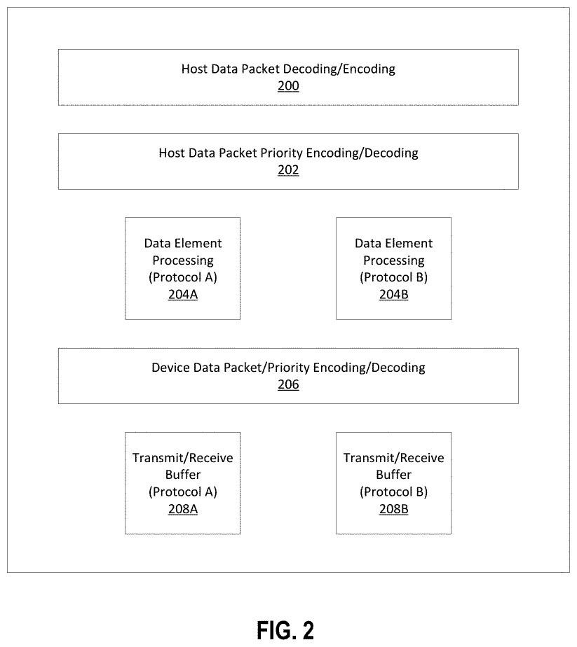

Referring to FIG. 2, a diagrammatic representation of functions performed by an embodiment of a bridge 102 is shown. Host data packets generated by the host device 104 in accordance with the host protocol are received at the unified adapter layer 110 via the host bus controller 112 and the network 106.

The unified adapter layer 110 is configured to implement host packet data decoding 200. The unified adapter layer 110 is configured to decode each received host data packet to generate one or more data elements associated with that host data packet. Examples of the data elements include, but are not limited to, command data elements, payload data elements and bus controller parameter settings.

The unified adapter layer 110 is configured to decode each received host data packet to determine the device 108A1, 108A2, 108B1, 108B2 that the host data packet is directed to and determine the protocol Protocol A, Protocol B associated with that device 108A1, 108A2, 108B1, 108B2. The unified adapter layer 110 is configured to associate the determined device 108A1, 108A2, 108B1, 108B2 and the determined protocol Protocol A, Protocol B associated with a host data packet with the data elements generated based on that host data packet. In an embodiment, a device address and the protocol Protocol A, Protocol B associated with the device 108A1, 108A2, 108B1, 108B2 that the host data packet is directed to is included in the host data packet and is used by the unified adapter layer 110 to identify the device 108A1, 108A2, 108B1, 108B2 that the host data packet is directed to and the protocol Protocol A, Protocol B associated with that device 108A1, 108A2, 108B1, 108B2.

In an embodiment, the unified adapter layer 110 is configured to implement host data packet priority decoding 202. The unified adapter layer 110 is configured to decode each received host data packet to determine the priority associated with that host data packet. The unified adapter layer 110 is configured to associate the priority associated with each host data packet with each of the data elements generated based on that host data packet. In an embodiment, a quality of service (QoS) parameter is included in the host data packet and is used by the unified adapter layer 110 to determine the priority associated with a host data packet. In an embodiment, the unified adapter layer 110 modifies a priority associated with a host data packet based on an interrupt received from a device 108A1, 108A2, 108B1, 108B2 such that the priority associated with the one or more host data packets directed to the device 108A1, 108A2, 108B1, 108B2 that generated the interrupt is assigned a higher priority than host data packets directed to other devices 108A1, 108A2, 108B1, 108B2. The data elements generated based on the one or more host data packets directed to the device 108A1, 108A2, 108B1, 108B2 that generated the interrupt are assigned a higher priority than the data elements based on the host data packets directed to the other devices 108A1, 108A2, 108B1, 108B2

In an embodiment, following the implementation of host packet data decoding 200 the unified adapter layer 110 is configured to place the data elements associated with the decoded host data packets in the packet buffer 116. In an embodiment, following the implementation of host packet data decoding 200 and the implementation of host data packet priority decoding 202, the unified adapter layer 110 is configured to place the data elements associated with the decoded host data packets in the packet buffer 116 in accordance with the priority associated with each of the data elements.

The one or more device bus controllers 114A, 114B are configured to implement data element processing 204A, 204B. Each device bus controller 114A, 114B is configured to process data elements in accordance with a specific protocol Protocol A, Protocol B. For example, device bus controller 114A is configured to implement data element processing 204A with respect to devices 108A1, 108A2 associated with Protocol A and device bus controller 114B is configured to implement data element processing 204B with respect to devices 108B1, 108B2 associated with Protocol B. Each device bus controller 114A, 114B is communicatively coupled to one or more devices 108A1, 108A2, 108B1, 108B2. Each device bus controller 114A, 114B retrieves data elements from the packet buffer 116 that are associated with the devices 108A1, 108A2, 108B1, 108B2 that are communicatively coupled to that device bus controller 114A, 114B and processes the retrieved data elements.

In an embodiment, the one or more device bus controllers 114A, 114B are configured to implement data element processing 204A, 204B on one or more of the retrieved data elements by packetizing one or more of the retrieved data elements in accordance with the protocol Protocol A, Protocol B associated with the devices 108A1, 108A2, 108B1, 108B2 communicatively coupled to that device bus controller 114A, 114B. In an embodiment, the device bus controllers 114A, 114B determines whether one or more of the retrieved data elements are a command data element or a payload data element and packetizes the data elements that the device bus controllers 114A, 114B identifies as a command data element or a payload data element to generate device data packets.

For example, the device bus controller 114A is communicatively coupled to devices 108A1, 108A2. The device bus controller 114A is configured to retrieve data elements from the packet buffer 116 that are associated with devices 108A1, 108A2. The device bus controller 114A determines whether one or more of the data elements is a command data element or a payload data element and packetizes the one or more data elements that have been identified as a command data element or a payload data element in accordance with the protocol Protocol A associated with devices 108A1, 108A2. Similarly, the device bus controller 114B is communicatively coupled to devices 108B1, 108B2. The device bus controller 114B is configured to retrieve data elements from the packet buffer 116 that are associated with devices 108B1, 108B2. The device bus controller 114B determines whether one or more of the data elements is a command data element or a payload data element and packetizes the one or more data elements that have been identified as a command data element or a payload data element in accordance with the protocol Protocol B associated with devices 108B1, 108B2.

In an embodiment, the device bus controllers 114A, 114B determines whether one or more of the retrieved data elements is a bus controller parameter setting and adjusts a bus controller parameter of a component of the device bus controller 114A, 114B in accordance with the bus controller parameter setting. In an embodiment, the data elements generated based on a host data packet include a bus controller parameter setting and one or both of command data element(s) and payload data element(s). The bus controller parameter setting defines a setting of a bus controller parameter of a component of the device bus controller 114A, 114B associated with the processing of the command data element(s) and/or payload data element(s) associated with the same host data packet. Examples of bus controller parameter settings include, but are not limited to a clock speed of a device bus controller 114A, 114B, a slew rate of a device bus controller 114A, 114B, and a drive strength of a device bus controller 114A, 114B. The device bus controller 114A, 114B implements data element processing 204A, 204B of a bus controller parameter setting by adjusting the bus controller parameter at the device bus controller 114A, 114B in accordance with the bus controller parameter setting defined by the data element prior to initiating communication with a device 108A1, 108A2, 108B1, 108B2 to implement processing of the command data element(s) and/or payload data element(s) associated with the bus controller parameter setting.

In an embodiment, the one or more device bus controllers 114A, 114B are configured to implement device data packet priority encoding 206. In an embodiment, as described above, the unified adapter layer 110 associates a priority with each of the data elements. When a device bus controllers 114A, 114B packetizes a data element to generate a device data packet, the device bus controller 114A, 114B assigns the priority associated with that data element to the generated device data packet. The device bus controllers 114A, 114B place each generated device data packet in a transmit buffer 208A, 208B associated with the device 108A1, 108A2, 108B1, 108B2 that the device data packet is directed to in accordance with the priority associated with that device data packet.

Each device bus controller 114A, 114B is configured to retrieve the device data packets from the transmit buffer 208A, 208B associated with a device 108A1, 108A2, 108B1, 108B2 that is communicatively coupled to that device bus controller 114A, 114B and transmit the device data packets to the device 108A1, 108A2, 108B1, 108B2 in accordance with the protocol Protocol A, Protocol B associated with the device 108A1, 108A2, 108B1, 108B2. In an embodiment, the device bus controllers 114A, 114B are configured to retrieve device data packets from the transmit buffers 208A, 208B and transmit the retrieved device data packets in accordance with the priority associated with each of the device data packets.

Each of the device bus controllers 114A, 114B are configured to receive device data packets generated by the devices 108A1, 108A2, 108B1, 108B2 that are communicatively coupled to that device bus controller 114A, 114B in accordance with the associated device protocol Protocol A, Protocol B. In an embodiment, the device bus controllers 114A, 114B are configured to place each received device data packets in a receive buffer 208A, 208B associated with the device 108A1, 108A2, 108B1, 108B2 that generated the device data packet. In an embodiment, the unified adapter layer 110 is configured to retrieve the device data packets from the receive buffer 208A, 208B. In an embodiment, the unified adapter layer 110 is configured to receive the device data packets from the device bus controller 114A, 114B.

The unified adapter layer 110 is configured to implement device packet data decoding 206. The unified adapter layer 110 is configured to decode each received device data packet to generate one or more data elements associated with that device data packet. Examples of the data elements include, but are not limited to, command data elements and payload data elements. In an embodiment, the unified adapter layer 110 is configured to implement device data packet priority decoding 206. The unified adapter layer 110 is configured to decode each received device data packet to determine the priority associated with that device data packet. The unified adapter layer 110 is configured to associate the priority associated with each device data packet with each of the data elements generated based on that device data packet. In an embodiment, a quality of service (QoS) parameter is included in the device data packet and is used by the unified adapter layer 110 to determine the priority associated with a device data packet. In an embodiment, the unified adapter layer 110 modifies a priority associated with a device data packet based on an interrupt received from a device 108A1, 108A2, 108B1, 108B2 such that the priority associated with the one or more device data packets generated by the device 108A1, 108A2, 108B1, 108B2 that generated the interrupt is assigned a higher priority than device data packets generated by the other devices 108A1, 108A2, 108B1, 108B2.

In an embodiment, following the implementation of device packet data decoding 206 the unified adapter layer 110 is configured to place the data elements associated with the decoded host data packets in the packet buffer 116. In an embodiment, following the implementation of device data packet decoding 206 and the implementation of device data packet priority decoding 206, the unified adapter layer 110 is configured to place the data elements associated with the decoded device data packets in the packet buffer 116 in accordance with the priority associated with each of the data elements.

The host bus controller 112 is configured to implement data element processing 204A, 204B. In an embodiment, the host bus controller 112 is configured to retrieve data elements from the packet buffer 116 and process the retrieved data elements. The host bus controller 112 is configured to implement data element processing 204A, 204B on the retrieved data elements by packetizing the retrieved data elements in accordance with the host protocol to generate host data packets for transmission to the host device 104. The host bus controller 112 is configured to transmit the generated host data packets to the host device 104 in accordance with the host protocol. In an embodiment, host bus controller 112 is configured to transmit the generated host data packets to the host device 104 in accordance with the priority associated with the data elements used to generate the host data packets. While one diagrammatic representation of functions performed by an embodiment of a bridge 102 has been described, alternative embodiments of the bridge 102 may perform a subset of the described functions, additional functions in addition to the described functions or perform the described functions in a different order.

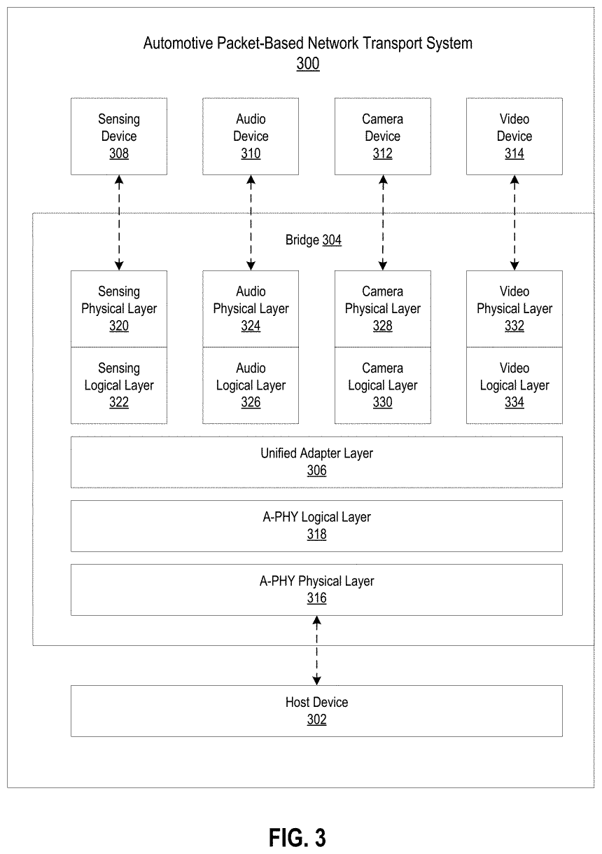

Referring to FIG. 3, a block diagram representation of an example of an automotive packet-based network transport system 300 including an embodiment of a unified adapter layer 306 is shown. The unified adapter layer 306 is similar to the unified adapter layer 110 shown in FIG. 1. The automotive packet-based network transport system 300 includes a host device 302, a bridge 304 including an embodiment of the unified adapter layer 306, a sensing device 308, an audio device 310, a camera device 312, and a video device 314.

The host device 302 is configured to communicate in accordance with an A-PHY protocol. The A-PHY protocol defines a A-PHY physical layer 316 and a A-PHY logical layer 318. The sensing device 308 is configured to communicate in accordance with a sensing device protocol. The sensing device protocol defines a sensing physical layer 320 and a sensing logical layer 322. The audio device 310 is configured to communicate in accordance with a audio device protocol. The audio device protocol defines a audio physical layer 324 and a audio logical layer 326. The camera device 312 is configured to communicate in accordance with a camera device protocol. The camera device protocol defines a camera physical layer 328 and a camera logical layer 330. The video device 314 is configured to communicate in accordance with a video device protocol. The video device protocol defines a video physical layer 332 and a video logical layer 334.

When the host device 302 generates one or more host data packets directed to the sensing device 308, the host data packet is packetized in accordance with the A-PHY logical layer 318 and transmitted to the bridge 304 in accordance with the A-PHY physical layer 316. The unified adapter layer 306 is configured to decode each of the host data packets to determine that the one or more host data packets are directed to the sensing device 308, the adaption type defining that the sensing device 308 is configured to communicate in accordance with the sensing device protocol, the priority associated with the host data packets, and the ordering of the host data packets. The unified adapter layer 306 is configured to generate data elements based on the host data packets and to associate the sensing device 308, the adaption type, the priority, and the ordering associated with a host data packet with the data elements generated based on that host data packet. A sensing device bus controller is communicatively coupled to the sensing device 308 via a bus and is configured to process the command data elements and the payload data elements to generate one or more sensing device data packets in accordance with the sensing logical layer 322 for transmission to the sensing device 308. The sensing device bus controller is configured to process sensor bus controller parameter setting(s) to adjust sensing bus controller parameter(s) of one or more sensing bus controller components associated with the transmission the sensing device data packets to the sensing device 308. The sensing device bus controller transmits the one or more sensing device data packets to the sensing device 308 in accordance with the sensing physical layer 320 based on the determined priority and the ordering.

When the sensing device 308 generates sensing device data packets for transmission to the host device 302, the sensing device data packets are packetized in accordance with the sensing logical layer 322 and transmitted to the bridge 304 in accordance with the sensing physical layer 320. The unified adapter layer 306 is configured to decode the sensing device data packets to determine the priority associated with the sensing device data packets and the ordering of the sensing device data packets. The unified adapter layer 306 is configured to generate data elements based on the sensing device data packets and associate the determined priority and ordering with the generated data elements. A host bus controller is configured to process one or more of the data elements to generate one or more host data packets in accordance with the A-PHY logical layer 318 for transmission to the host device 302. The host bus controller transmits the one or more host data packets to the host device 302 in accordance with the A-PHY physical layer 316 based on the determined priority and ordering.

When the host device 302 generates one or more host data packets directed to the audio device 310, the host data packet is packetized in accordance with the A-PHY logical layer 318 and transmitted to the bridge 304 in accordance with the A-PHY physical layer 316. The unified adapter layer 306 is configured to decode each of the host data packets to determine that the one or more host data packets are directed to the audio device 310, the adaption type defining that the audio device 310 is configured to communicate in accordance with the audio device protocol, the priority associated with the host data packets, and the ordering of the host data packets. The unified adapter layer 306 is configured to generate data elements based on the host data packets and to associate the audio device 310, the adaption type, the priority, and the ordering associated with a host data packet with the data elements generated based on that host data packet. An audio device bus controller is communicatively coupled to the audio device 310 via a bus and is configured to process the command data elements and the payload data elements to generate one or more audio device data packets in accordance with the audio logical layer 326 for transmission to the audio device 310. The audio device bus controller is configured to process audio bus controller parameter setting(s) to adjust audio bus controller parameter(s) of one or more audio bus controller components associated with the transmission the audio device data packets to the audio device 310. The audio device bus controller transmits the one or more audio device data packets to the audio device 310 in accordance with the audio physical layer 324 based on the determined priority and the ordering.

When the audio device 310 generates audio device data packets for transmission to the host device 302, the audio device data packets are packetized in accordance with the audio logical layer 326 and transmitted to the bridge 304 in accordance with the audio physical layer 324. The unified adapter layer 306 is configured to decode the audio device data packets to determine the priority associated with the audio device data packets and the ordering of the audio device data packets. The unified adapter layer 306 is configured to generate data elements based on the audio device data packets and associate the determined priority and ordering with the generated data elements. A host bus controller is configured to process one or more of the data elements to generate one or more host data packets in accordance with the A-PHY logical layer 318 for transmission to the host device 302. The host bus controller transmits the one or more host data packets to the host device 302 in accordance with the A-PHY physical layer 316 based on the determined priority and ordering.

When the host device 302 generates one or more host data packets directed to the camera device 312, the host data packet is packetized in accordance with the A-PHY logical layer 318 and transmitted to the bridge 304 in accordance with the A-PHY physical layer 316. The unified adapter layer 306 is configured to decode each of the host data packets to determine that the one or more host data packets are directed to the camera device 312, the adaption type defining that the camera device 312 is configured to communicate in accordance with the camera device protocol, the priority associated with the host data packets, and the ordering of the host data packets. The unified adapter layer 306 is configured to generate data elements based on the host data packets and to associate the camera device 312, the adaption type, the priority, and the ordering associated with a host data packet with the data elements generated based on that host data packet. A camera device bus controller is communicatively coupled to the camera device 312 via a bus and is configured to process the command data elements and the payload data elements to generate one or more camera device data packets in accordance with the camera logical layer 330 for transmission to the camera device 312. The camera device bus controller is configured to process camera bus controller parameter setting(s) to adjust camera bus controller parameter(s) of one or more camera bus controller components associated with the transmission the camera device data packets to the camera device 312. The camera device bus controller transmits the one or more camera device data packets to the camera device 312 in accordance with the camera physical layer 328 based on the determined priority and the ordering.

When the camera device 312 generates camera device data packets for transmission to the host device 302, the camera device data packets are packetized in accordance with the camera logical layer 330 and transmitted to the bridge 304 in accordance with the camera physical layer 328. The unified adapter layer 306 is configured to decode the camera device data packets to determine the priority associated with the camera device data packets and the ordering of the camera device data packets. The unified adapter layer 306 is configured to generate data elements based on the camera device data packets and associate the determined priority and ordering with the generated data elements. A host bus controller is configured to process one or more of the data elements to generate one or more host data packets in accordance with the A-PHY logical layer 318 for transmission to the host device 302. The host bus controller transmits the one or more host data packets to the host device 302 in accordance with the A-PHY physical layer 316 based on the determined priority and ordering.

When the host device 302 generates one or more host data packets directed to the video device 314, the host data packet is packetized in accordance with the A-PHY logical layer 318 and transmitted to the bridge 304 in accordance with the A-PHY physical layer 316. The unified adapter layer 306 is configured to decode each of the host data packets to determine that the one or more host data packets are directed to the video device 314, the adaption type defining that the video device 314 is configured to communicate in accordance with the video device protocol, the priority associated with the host data packets, and the ordering of the host data packets. The unified adapter layer 306 is configured to generate data elements based on the host data packets and to associate the video device 314, the adaption type, the priority, and the ordering associated with a host data packet with the data elements generated based on that host data packet. A video device bus controller is communicatively coupled to the video device 314 via a bus and is configured to process the command data elements and the payload data elements to generate one or more video device data packets in accordance with the video logical layer 334 for transmission to the video device 314. The video device bus controller is configured to process video bus controller parameter setting(s) to adjust video bus controller parameter(s) of one or more video bus controller components associated with the transmission the video device data packets to the video device 314. The video device bus controller transmits the one or more video device data packets to the video device 314 in accordance with the video physical layer 332 based on the determined priority and the ordering.

When the video device 314 generates video device data packets for transmission to the host device 302, the video device data packets are packetized in accordance with the video logical layer 334 and transmitted to the bridge 304 in accordance with the video physical layer 332. The unified adapter layer 306 is configured to decode the video device data packets to determine the priority associated with the video device data packets and the ordering of the video device data packets. The unified adapter layer 306 is configured to generate data elements based on the video device data packets and associate the determined priority and ordering with the generated data elements. A host bus controller is configured to process one or more of the data elements to generate one or more host data packets in accordance with the A-PHY logical layer 318 for transmission to the host device 302. The host bus controller transmits the one or more host data packets to the host device 302 in accordance with the A-PHY physical layer 316 based on the determined priority and ordering.

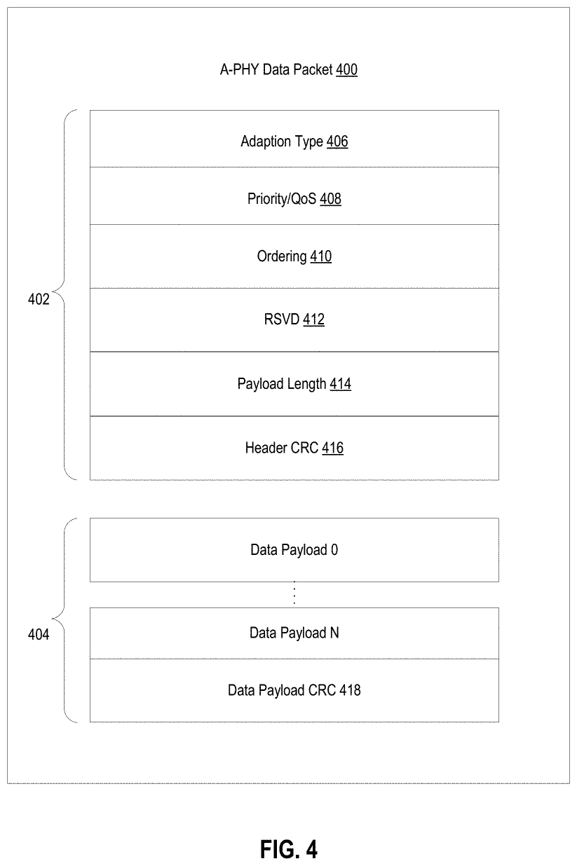

Referring to FIG. 4, a block diagram representation of an example of A-PHY data packet format 400 is shown. The A-PHY packet format 400 includes a header 402 and a payload 404. The header 402 includes an adaption type 406 that defines a protocol associated with the device 108A1, 108A2, 108B1, 108B2 that the host data packet is directed to, a priority 408 that defines a priority/QoS associated with the host data packet, an ordering 410 associated with the host data packet, a reserved field 412, a payload length 414, and header error correction data 416. The payload 404 includes data payloads 0-N and data payload error correction data 418. Reserved fields may be used in the A-PHY Data Packet Format and can be decoded by the adaption layer to route data to the respective physical layer taking into account QoS and ordering rule. Table 1 below provides examples of the adaption type, the priority/QoS, and the ordering that may be included in the header 402 of the A-APHY data packet.

TABLE 1
Header Packet Decoding

| Field | Sub Field | Bits | Descriptions |
|---|---|---|---|
| Adaption type | Adaption | 3:0 | 0; PHY Specific |
| | Type | | 1: Link Specific |
| | | | 2: Clock Specific |
| | | | 3: MIPI I3C |
| | | | 4: GPIO |
| | | | 5: I2C |
| | | | 6: MIPI I3S |
| | | | 7: MIPI Sound-wire |
| | | | 8: RFE |
| | | | 9: I2S |
| | | | 10: USB |
| | | | 11: Non-Standard |
| | | | 12: MIPI DSI |
| | | | 13: MIPI CSI2 |
| | | | 14: MIPI DPHY |
| | | | 15: MIPI MPHY |
| Priority/QOS | Priority | 3:0 | 0: Reserved |
| | | | 1; Normal Priority (large |
| | | | payload size) |
| | | | 2: Medium Priority |
| | | | 3: Highest priority (mainly |
| | | | for low payload size) |
| | QOS | 1:0 | 0; Timing sensitive |
| | | | 1: Flow sensitive |
| | | | 2: Regular flow |
| | | | 3: Optimize for utilization |
| | BAD | | 1: Bad APHY packet |
| Ordering | Adaption | 2:0 | Specific to HCI-APHY |
| | layer | | adapter layer |
| | Byte Type | 1 | 0: even Bytes |
| | | | 1: Odd Bytes |
| | Ordering | 1:0 | 0: Middle frame |
| | | | 1: First Frame |
| | | | 2: Last Frame |
| | | | 3: Only Header |

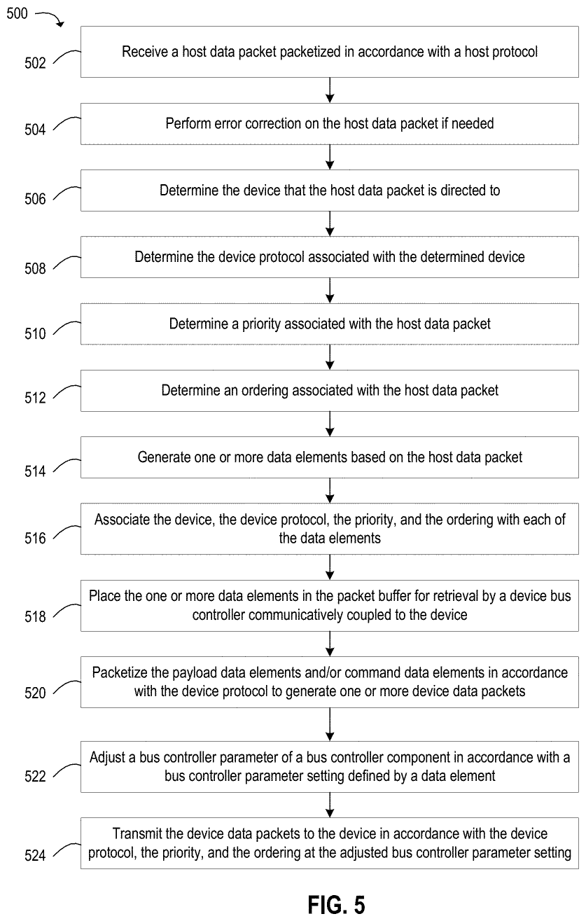

Referring to FIG. 5, a flow chart representation of an example of a method 500 of processing host data packets associated with a host protocol for transmission to a device 108A1, 108A2, 108B1, 108B2 associated with a device protocol Protocol A, Protocol B using an embodiment of a bridge 102 is shown. The method 500 is performed by an embodiment of the bridge 102. The method 500 may be performed by the bridge 102 in combination with additional components of the system 100. The method 500 may be performed by hardware circuitry, firmware, software, and/or combinations thereof. The method 500 is described with reference to FIG. 1.

At 502, a host data packet packetized in accordance with a host protocol is received from the host device 104 at the host bus controller 112 of the bridge 102. The unified adapter layer 110 performs error correction on the received host data packet if needed at 504. The unified adapter layer 110 determines the device 108A1, 108A2, 108B1, 108B2 that the host data packet is directed to at 506. In an embodiment, the unified adapter layer 110 determines the device 108A1, 108A2, 108B1, 108B2 that the host data packet is directed to based on a device address included in the host data packet. In an embodiment, the unified adapter layer 110 checks the operational status of the different devices 108A1, 108A2, 108B1, 108B2 stored at the configuration circuit 118 and determines the device that the host data packet is directed to based on the operational status of the devices 108A1, 108A2, 108B1, 108B2.

The unified adapter layer 110 determines the device protocol associated with the device 108A1, 108A2, 108B1, 108B2 that the host data packet is directed to at 508. In an embodiment, the host data packet includes an adaption type that defines the device protocol. The unified adapter layer 110 determines a priority associated with the host data packet at 510. In an embodiment, the host data packet includes a priority/QoS associated with the host data packet and the unified adapter layer 110 determines the priority based on the priority/QoS included in the host data packet. In an embodiment, the unified adapter layer 110 may receive an interrupt from a device 108A1, 108A2, 108B1, 108B2 and the unified adapter layer 110 may prioritize host data packets directed to the device 108A1, 108A2, 108B1, 108B2 that generated the interrupt over host data packets directed to the other devices 108A1, 108A2, 108B1, 108B2.

The unified adapter layer 110 determines an ordering associated with the host data packet at 512. In an embodiment, the ordering is included in the host data packet and the unified adapter layer 110 determines the ordering based on the ordering included in the host data packet. The unified adapter layer 110 generates one or more data elements based on the host data packet at 514. Examples of the data elements include, but are not limited to, a command data element, a payload data element and a bus controller parameter setting. At 516, the unified adapter layer 110 associates the device, the device protocol, the priority, and the ordering with each of the generated data elements and places the one or more data elements in the packet buffer 116 for retrieval by the device bus controller 114A, 114B that is communicatively coupled to the device 108A1, 108A2, 108B1, 108B2 at 518.

The device bus controller 114A, 114B retrieves the data elements from the packet buffer 116 and packetizes the command data elements and/or payload data elements in accordance with the device protocol to generate one or more device data packets at 520. The device bus controller 114A, 114B adjusts a bus controller parameter of a bus controller component in accordance with a bus controller parameter setting defined by a retrieved data element at 522. The device bus controller 114A, 114B transmits the device data packets to the device 108A1, 108A2, 108B1, 108B2 in accordance with the device protocol, the priority, and the ordering at the adjusted bus controller parameter setting at 524. It is to be understood that the method 500 is shown at a high level in FIG. 5 and that many variations in and alternatives of the method 500 are possible.

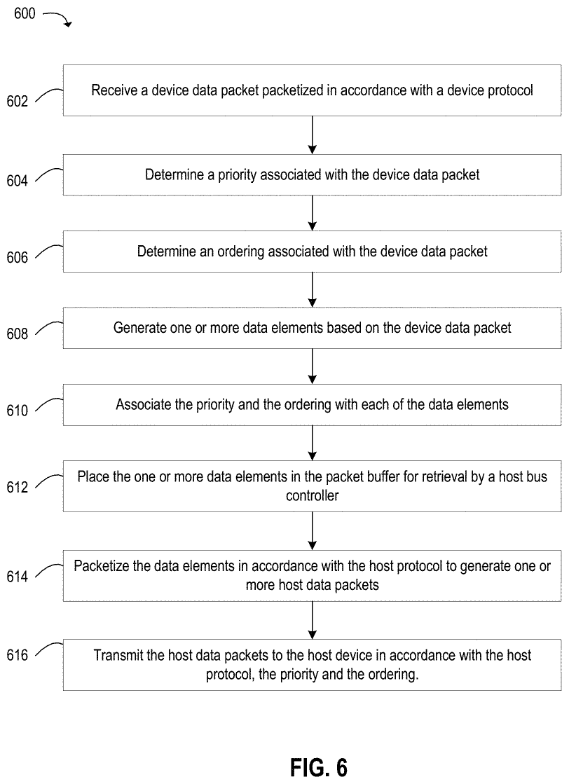

Referring to FIG. 6, a flow chart representation of an example of a method 600 of processing device packets associated with a device protocol for transmission to a host device 104 associated with a host protocol using an embodiment of a bridge 102 is shown. The method 600 is performed by an embodiment of the bridge 102. The method 600 may be performed by the bridge 102 in combination with additional components of the system 100. The method 600 may be performed by hardware circuitry, firmware, software, and/or combinations thereof. The method 600 is described with reference to FIG. 1.

At 602, a device data packet packetized in accordance with a device protocol Protocol A, Protocol B is received from a device 108A1, 108A2, 108B1, 108B2 at the device bus controller 114A, 114B that is communicatively coupled to that device 108A1, 108A2, 108B1, 108B2 via a bus. The unified adapter layer 110 determines a priority associated with the device data packet at 604. In an embodiment, the device data packets are prioritized in the order that the device data packets are received at the bridge 102. In an embodiment, the unified adapter layer 110 may receive an interrupt from a device 108A1, 108A2, 108B1, 108B2 and the unified adapter layer 110 may prioritize device data packets from the device 108A1, 108A2, 108B1, 108B2 that generated the interrupt over device data packets received from the other devices 108A1, 108A2, 108B1, 108B2. The unified adapter layer 110 determines an ordering associated with the device data packet at 606. In an embodiment, the ordering is included in the device data packet and the unified adapter layer 110 determines the ordering based on the ordering included in the device data packet.

The unified adapter layer 110 generates one or more data elements based on the device data packet at 608. Examples of the data elements include, but are not limited to, a command data element and a payload data element. At 610, the unified adapter layer 110 associates the priority and the ordering with each of the generated data elements and places the one or more data elements in the packet buffer 116 for retrieval by the host bus controller 112 at 612.

The host bus controller 112 retrieves the data elements from the packet buffer 116 and packetizes the command data elements and/or payload data elements in accordance with the host protocol to generate one or more host data packets at 614. The host bus controller 112 transmits the host data packets to the host device 104 in accordance with the host protocol, the priority, and the ordering via the network 106 at 616. It is to be understood that the method 600 is shown at a high level in FIG. 6 and that many variations in and alternatives of the method 600 are possible.

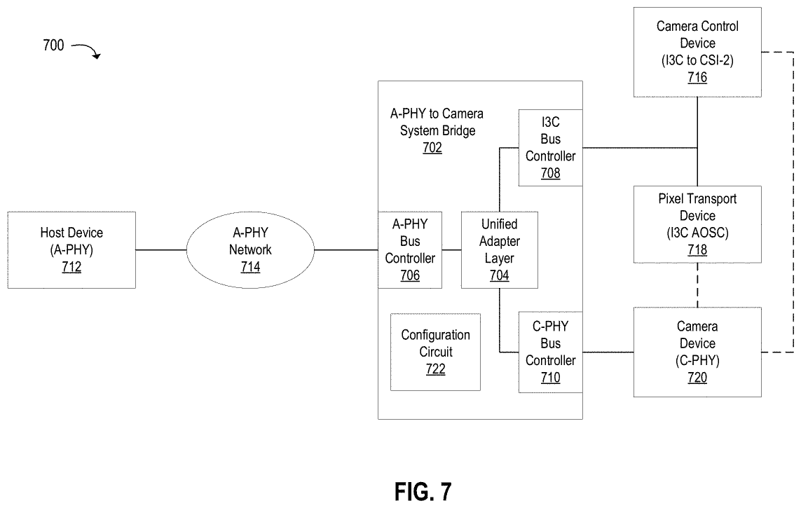

Referring to FIG. 7, a block diagram representation of an example of a system 700 including an embodiment of a A-PHY to camera system bridge 702 is shown. The A-PHY to camera system bridge 702 includes an embodiment of a unified adapter layer 704. The unified adapter layer 704 shown in FIG. 7 is similar to the unified adapter layer 110 shown in FIG. 1. The A-PHY to camera system bridge 702 includes the unified adapter layer 704, a A-PHY bus controller 706, a I3C bus controller 708, and a C-PHY bus controller 710. A host device 712 is configured to be communicatively coupled to the A-PHY bus controller 706 via a A-PHY network 714. A camera control device 716 and a pixel transport device 718 are configured to be communicatively coupled to the I3C bus controller 708. A camera device 720 is configured to be communicatively coupled to the C-PHY bus controller 710.

The host device 704 is configured to generate a plurality of host data packets that are packetized in accordance with the A-PHY protocol. Each of the plurality of host data packets are directed to the camera control device 716, the pixel transport device 718 or the camera device 720. The host device 704 is configured to transmit the host data packets to the A-PHY bus controller 706 via the A-PHY network 714 in accordance with the A-PHY protocol.

The unified adapter layer 704 is configured to decode the received host data packets that are packetized in accordance with the A-PHY protocol. In an embodiment, the unified adapter layer 704 is configured to review the header of each received host data packet to determine the device 716, 718, 720 that the host data packet is directed to, the protocol I3C, C-PHY associated with that device 716, 718, 720, the priority associated with the host data packet, and the ordering of the host data packet. The unified adapter layer 704 is configured to review each of the received host data packets for error and implement error correction upon detection of an error. The unified adapter layer 704 is configured to generate one or more data elements based on each of the received host data packets. Examples of the data elements include a command data element, a payload data element, and a bus controller parameter setting. The unified adapter layer 704 is configured to associated each of the data elements based on a host data packet with the device 716, 718, 720 that the host data packet is directed to, the protocol I3C, C-PHY associated with that device 716, 718, 720, the priority associated with the host data packet, and the ordering of the host data packet.

In an embodiment, the A-PHY to camera system bridge 702 includes a configuration circuit 722. The configuration circuit 722 is configured to store configuration data associated with each of the devices 716, 718, 720. The unified adapter layer 704 is configured to retrieve configuration data associated with each of the devices 716, 718, 720 from the configuration circuit 722 to determine the specific device 716, 718, 720 that a received host data packet is directed to based on an operational status of each of the devices 716, 718, 720. Examples of operational statuses include, but are not limited to, an on status, an off status, an idle status, an always on status, and an active status. The unified adapter layer 704 is configured to determine that a received host data packet is directed to a device 716, 718, 720 in an operational status of, for example, an on status, an always on status, or an active status.

The I3C bus controller 708 is configured to retrieve data elements that the unified adapter layer 704 has associated with the camera control device 716 and the pixel transport device 718. If a retrieved data element is a command data element or a payload data element, the I3C bus controller 708 packetizes the data element in accordance with the I3C protocol to generate a device data packet for transmission to the device 716, 718 associated with the data element. If a retrieved data element is a bus controller parameter setting associated with a command data element and/or payload data element, the I3C bus controller 708 is configured to adjust one or more bus controller components in accordance with the bus controller parameter setting prior to transmission of the device data packets based on the associated data elements to the device 716, 718 in accordance with the I3C protocol.

The C-PHY bus controller 710 is configured to retrieve data elements that the unified adapter layer 704 has associated with the camera device 720. If a retrieved data element is a command data element or a payload data element, the C-PHY bus controller 710 packetizes the data element in accordance with the C-PHY protocol to generate a device data packet for transmission to the camera device 720. If a retrieved data element is a bus controller parameter setting associated with a command data element and/or payload data element, the C-PHY bus controller 710 is configured to adjusts one or more bus controller components in accordance with the bus controller parameter setting prior to transmission of the device data packets based on the associated command data elements and/or payload data elements to the camera device 720 in accordance with the C-PHY protocol.

The camera control device 716 and the pixel transport device 718 are configured to generate device data packets that are packetized in accordance with the I3C protocol. The camera control device 716 and the pixel transport device 718 are configured to transmit the device data packets to the I3C bus controller 708 in accordance with the I3C protocol.

The unified adapter layer 704 is configured to decode the received device data packets that are packetized in accordance with the I3C protocol. In an embodiment, the unified adapter layer 704 is configured to determine the priority associated with each device data packet. The unified adapter layer 704 is configured to generate one or more data elements based on each of the received device data packets. The unified adapter layer 704 is configured to associated each of the data elements based on a device data packet with the priority associated with that device data packet.

In an embodiment, the unified adapter layer 704 is configured to retrieve configuration data associated with each of the devices 716, 718, 720 from the configuration circuit 722 to determine the priority associated with each of the device data packets based on the device 716, 718, 720 associated with that the device data packet. In an embodiment, the unified adapter layer 704 prioritizes device data packets received from a device 716, 718, 720 that generates an interrupt over device data packets received from the other devices 716, 718, 720.

The A-PHY bus controller 706 is configured to retrieve data elements generated by the unified adapter layer 704 and to packetize the data elements in accordance with the A-PHY protocol to generate host data packets for transmission to the host device 712. The A-PHY bus controller 706 transmits the generated host data packets based on the priority associated with the data elements used to generate the host data packets. In an embodiment, the camera control device 716 is configured to be communicatively coupled to the camera device 720 and the pixel transport device 718. In an embodiment, the pixel transport device 718 is configured to be communicatively coupled to the camera control device 716 and the camera device 720. In an embodiment, the camera device 720 is configured to be communicatively coupled to the camera control device 716 and the pixel transport device 718.

In an embodiment, the A-PHY to camera system bridge 702 is implemented in a vehicle. When the vehicle is in a low power mode, such as for example parked or standby mode, the always on (AOSC) devices may communicate in accordance the I3C protocol. When the vehicle is in active driving mode, the I3C may provide a control path (CSI-2).

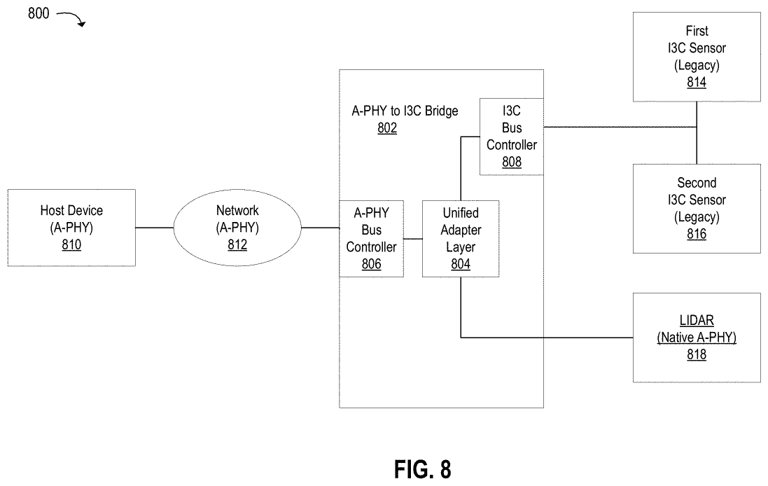

Referring to FIG. 8, a block diagram representation of an example of a system 800 including a A-PHY to I3C bridge 802 is shown. The A-PHY to I3C bridge 802 includes an embodiment of a unified adapter layer 804. The unified adapter layer 804 shown in FIG. 8 is similar to the unified adapter layer 110 shown in FIG. 1. The A-PHY to I3C bridge 802 includes the unified adapter layer 804, a A-PHY bus controller 806 and a I3C bus controller 808. A host device 810 is configured to be communicatively coupled to the A-PHY bus controller 806 via a A-PHY network 812. A first legacy sensor 814 and a second legacy sensor 816 are configured to be communicatively coupled to the I3C bus controller 808. A light detection and ranging (LIDAR) device 818 is configured to be communicatively coupled to the unified adapter layer 804.

The host device 810 is configured to generate a plurality of host data packets that are packetized in accordance with the A-PHY protocol. Each of the plurality of host data packets are directed to the first legacy sensor device 814, the second legacy sensor device 816 or the LIDAR device 818. The host device 810 is configured to transmit the host data packets to the A-PHY bus controller 806 via the A-PHY network 812 in accordance with the A-PHY protocol.

The unified adapter layer 804 is configured to decode the received host data packets that are packetized in accordance with the A-PHY protocol. In an embodiment, the unified adapter layer 804 is configured to review the header of each received host data packet to determine the device 814, 816, 818 that the host data packet is directed to, the protocol I3C, A-PHY associated with that device 814, 816, 818, the priority associated with the host data packet, and the ordering of the host data packet. The unified adapter layer 804 is configured to review each of the received host data packets for error and implement error correction upon detection of an error.

If the unified adapter layer 804 determines that the host data packet is directed to the LIDAR device 818, the unified adapter layer 804 is configured allow the host data packet to pass through the A-PHY to I3C bridge 802 to the LIDAR device 818 in accordance with the A-PHY protocol. In alternative embodiment, the unified adapter layer 804 may perform additional processing of the host data packet prior to transmission of the host data packet o the LIDAR device 818. The protocol associated with data packets received from the host device is the same as the protocol associated with the LIDAR device 818.

If the unified adapter layer 804 determines that the host data packet is directed to the first legacy sensor device 814 or the second legacy sensor device 816, the unified adapter layer 804 is configured to generate one or more data elements based on each of the received host data packets. Examples of the data elements include a command data element, a payload data element, and a bus controller parameter setting. The unified adapter layer 804 is configured to associated each of the data elements based on a host data packet with the device 814, 816, the priority associated with the host data packet, and the ordering of the host data packet.

The I3C bus controller 808 is configured to receive the data elements generated by the unified adapter layer 804. If a data element is a command data element or a payload data element, the I3C bus controller 808 packetizes the data element in accordance with the I3C protocol to generate a device data packet for transmission to the device 814, 816 associated with the data element. If a data element is a bus controller parameter setting associated with a command data element and/or payload data element, the I3C bus controller 808 is configured to adjust one or more bus controller components in accordance with the bus controller parameter setting prior to transmission of the device data packets based on the associated data elements to the device 814, 816 in accordance with the I3C protocol.

The first legacy sensor device 814 and the second legacy sensor device 816 are configured to generate device data packets that are packetized in accordance with the I3C protocol and transmit the device data packets to the I3C bus controller 808 in accordance with the I3C protocol. The LIDAR device 818 is configured to generate device data packets that are packetized in accordance with the A-PHY protocol and transmit the device packets to the A-PHY to I3C bridge 802 in accordance with the A-PHY protocol.

The unified adapter layer 804 is configured to decode the received device data packets that are packetized in accordance with the I3C protocol. In an embodiment, the unified adapter layer 804 is configured to determine the priority associated with each device data packet. The unified adapter layer 804 is configured to generate one or more data elements based on each of the device data packets and associate each of the data elements based on a device data packet with the priority associated with that device data packet.

The A-PHY bus controller 806 is configured to receive data elements generated by the unified adapter layer 804 and to packetize the data elements in accordance with the A-PHY protocol to generate host data packets for transmission to the host device 810. If the unified adapter layer 804 determines that a received device data packet is configured in accordance with the A-PHY protocol, the unified adapter layer 804 is configured allow the device data packet to pass through to the A-PHY bus controller 806 for transmission to the host device 810 in accordance with the A-PHY protocol.

The A-PHY bus controller 806 transmits the generated host data packets based on the data elements associated with the first legacy device 814 and the second legacy device 816, and device data packets received from the LIDAR device 818 based on the priority associated with the data elements used to generate the host data packets and a priority associated with device data packets generated by the LIDAR device 818. In an embodiment, the unified adapter layer 804 to configured to determine the priority associated with each of the device data packets based on the device 814, 816, 818 that the device data packet was received from. In an embodiment, the unified adapter layer 804 prioritizes device data packets received from a device 814, 816, 818 that generates an interrupt over device data packets received from the other devices 814, 816, 818.

The implementation of the system 800 enables communications with both legacy (I3C) sensors 814, 816 and advanced sensors 818 and may be scalable for future co-existence with native A-PHY protocols (or other PALs).

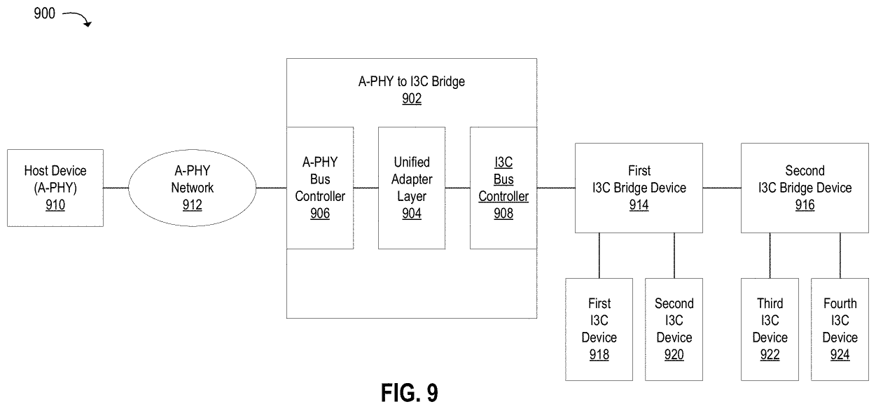

Referring to FIG. 9, a block diagram representation of an example of a system 900 including an embodiment of a A-PHY to I3C bridge 902 is shown. The A-PHY to I3C bridge 902 includes an embodiment of a unified adapter layer 904. The unified adapter layer 904 shown in FIG. 9 is similar to the unified adapter layer 110 shown in FIG. 1. The A-PHY to I3C bridge 902 includes the unified adapter layer 904, a A-PHY bus controller 906 and a I3C bus controller 908. A host device 910 is configured to be communicatively coupled to the A-PHY bus controller 906 via a A-PHY network 912. A first I3C bridge device 914 and a second I3C bridge device 916 are configured to be communicatively coupled to the I3C bus controller 908 via a I3C bus. The first I3C bridge device 914 is configured to be communicatively coupled to a first I3C device 918 and a second I3C device 920. The second I3C bridge device 916 is configured to be communicatively coupled to a third I3C device 922 and a fourth I3C device 924.

The host device 910 is configured to generate a plurality of host data packets that are packetized in accordance with the A-PHY protocol. Each of the plurality of host data packets are directed to one of the first I3C device 918 and the second I3C device 920 via the first I3C bridge device 914 or to one of the third I3C device 922 and the fourth I3C device 924 via the second I3C bridge device 916. The host device 810 is configured to transmit the host data packets to the A-PHY bus controller 906 via the A-PHY network 912 in accordance with the A-PHY protocol.

The unified adapter layer 904 is configured to decode the received host data packets that are packetized in accordance with the A-PHY protocol. In an embodiment, the unified adapter layer 904 is configured to review the header of each received host data packet to determine whether the host data packet is to be directed to the first I3C bridge device 914 or to the second I3C bridge device 916, the priority associated with the host data packet, and the ordering of the host data packet. The unified adapter layer 904 is configured to review each of the received host data packets for error and implement error correction upon detection of an error.

The unified adapter layer 904 is configured to generate one or more data elements based on each of the received host data packets. Examples of the data elements include a command data element, a payload data element, and a bus controller parameter setting. The unified adapter layer 904 is configured to associated each of the data elements based on a host data packet with one of the first I3C bridge device 914 and the second I3C bridge device 916, the priority associated with the host data packet, and the ordering associated with the host data packet.

The I3C bus controller 908 is configured to receive the data elements generated by the unified adapter layer 904. If a data element is a command data element or a payload data element, the I3C bus controller 908 is configured to packetize the data element in accordance with the I3C protocol to generate a device data packet for transmission to the one of the first I3C bridge device 914 and the second I3C bridge device 916 associated with the data element. If a data element is a bus controller parameter setting associated with a command data element and/or payload data element, the I3C bus controller 908 is configured to adjust one or more bus controller components in accordance with the bus controller parameter setting prior to transmission of the device data packets based on the associated data elements to the one of the first I3C bridge device 914 and the second I3C bridge device 916 associated with the data element in accordance with the I3C protocol.

If the device data packet is transmitted to the first I3C bridge device 914, the first I3C bridge device 914 is configured to determine whether the device data packet is directed to the first I3C device 918 or the second I3C device 920 and routes the device data packet accordingly. If the device data packet is transmitted to the second I3C bridge device 916, the second I3C bridge device 916 is configured to determine whether the device data packet is directed to the third I3C device 922 or the fourth I3C device 924 and routes the device data packet accordingly.

The first I3C device 918, the second I3C device 920, the third I3C device 922, and the fourth I3C device 924 are configured to generate device data packets that are packetized in accordance with the I3C protocol. The first I3C device 918 and the second I3C device 920 are configured to transmit the device data packets to the first I3C bridge device 914. The first I3C bridge device 914 is configured to transmit the received device data packets to the I3C bus controller 908 in accordance with the I3C protocol. The third I3C device 922 and the fourth I3C device 924 are configured to transmit the device data packets to the second I3C bridge device 916. The second I3C bridge device 916 is configured to transmit the received device data packets to the I3C bus controller 908 in accordance with the I3C protocol

The unified adapter layer 904 is configured to decode the received device data packets that are packetized in accordance with the I3C protocol. In an embodiment, the unified adapter layer 904 is configured to determine the priority associated with each device data packet. The unified adapter layer 904 is configured to generate one or more data elements based on each of the received device data packets and associate each of the data elements based of a device data packet with the priority associated with that device data packet.

The A-PHY bus controller 906 is configured to receive data elements generated by the unified adapter layer 904 and packetize the data elements in accordance with the A-PHY protocol to generate host data packets for transmission to the host device 910. The A-PHY bus controller 906 is configured to transmit the generated host data packets based on the priority associated with the data elements used to generate the host data packets. In an embodiment, the unified adapter layer 904 is configured to determine the priority associated with each of the device data packets based on a priority associated with the device 914, 916 that generated the device data packet. In an embodiment, the unified adapter layer 904 prioritizes device data packets received from a device 914, 916 that generates an interrupt over device data packets received from the other devices 914, 916.

The system 900 enables multiple I3C bridge devices to exist on the same A-PHY network. Each has a separate I3C Bus and they do not interact with each other. The A-PHY Host sees separate I3C address domains for the different I3C bridge devices.

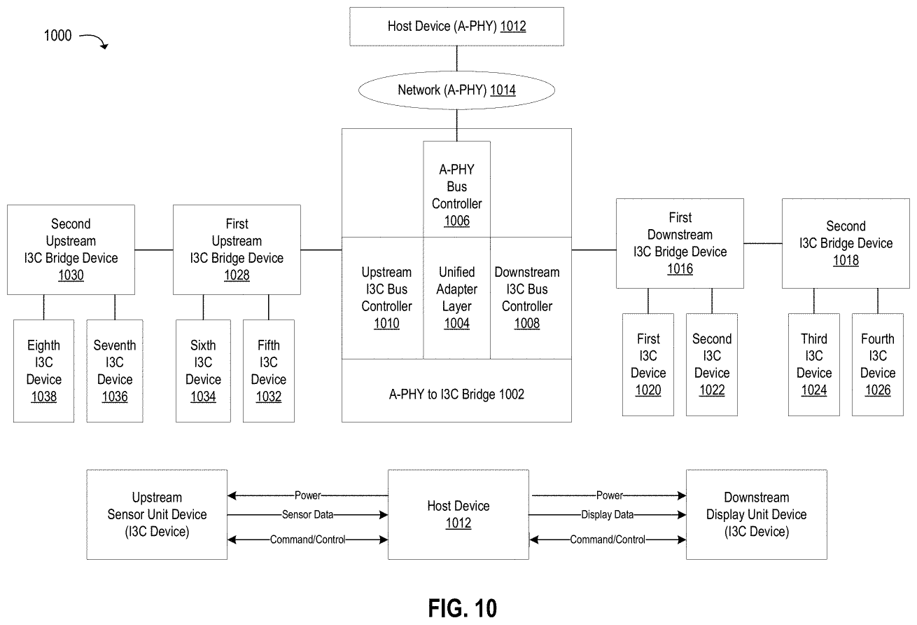

Referring to FIG. 10, a block diagram representation of an example of a system 1000 including an embodiment of a A-PHY to I3C bridge 1002 is shown

The A-PHY to I3C bridge 1002 includes an embodiment of a unified adapter layer 1004. The unified adapter layer 1004 shown in FIG. 10 is similar to the unified adapter layer 110 shown in FIG. 1. The A-PHY to I3C bridge 1002 includes the unified adapter layer 1004, a A-PHY bus controller 1006, a downstream I3C bus controller 1008, and an upstream I3C bus controller 1010. A host device 1012 is configured to be communicatively coupled to the A-PHY bus controller 1006 via a A-PHY network 1014.

A first downstream I3C bridge device 1016 and a second downstream I3C bridge device 1018 are configured to be communicatively coupled to the downstream I3C bus controller 1008 via a bus. The first downstream I3C bridge device 1016 is configured to be communicatively coupled to a first I3C device 1020 and a second I3C device 1022. The second downstream I3C bridge device 1018 is configured to be communicatively coupled to a third I3C device 1024 and a fourth I3C device 1026. A first upstream I3C bridge device 1028 and a second upstream I3C bridge device 1030 are configured to be communicatively coupled to the upstream I3C bus controller 1010 via a bus. The first upstream I3C bridge device 1028 is configured to be communicatively coupled to a fifth I3C device 1032 and a sixth I3C device 1034. The second upstream I3C bridge device 1030 is configured to be communicatively coupled to a seventh I3C device 1036 and an eighth I3C device 1038.

The host device 1012 is configured to generate a plurality of host data packets that are packetized in accordance with the A-PHY protocol. Each of the plurality of host data packets are directed to one of the first I3C device 1020 and the second I3C device 1022 via the first downstream I3C bridge device 1016, one of the third I3C device 1024 and the fourth I3C device 1026 via the second downstream I3C bridge device 1018, one of the fifth I3C device 1032 and the sixth I3C device 1034 via the first upstream I3C bridge device 1028, or one of the seventh I3C device 1036 and the eighth I3C device 1038 via the second upstream I3C bridge device 1030. The host device 1012 is configured to transmit the host data packets to the A-PHY bus controller 1006 via the A-PHY network 1014 in accordance with the A-PHY protocol.

The unified adapter layer 1004 is configured to decode the received host data packets that are packetized in accordance with the A-PHY protocol. In an embodiment, the unified adapter layer 1004 is configured to review the header of each received host data packet to determine whether the host data packet is to be directed to the first downstream I3C bridge device 1016, the second downstream I3C bridge device 1018, the first upstream I3C bridge device 1028, or the second upstream I3C bridge device 1030, the priority associated with the host data packet, and the ordering of the host data packet. The unified adapter layer 1004 is configured to review each of the received host data packets for error and implement error correction upon detection of an error.

The unified adapter layer 1004 is configured to generate one or more data elements based on each of the received host data packets. Examples of the data elements include a command data element, a payload data element, and a bus controller parameter setting. The unified adapter layer 1004 is configured to associated each of the data elements based on a host data packet with the first downstream I3C bridge device 1016, the second downstream I3C bridge device 1018, the first upstream I3C bridge device 1028, or the second upstream I3C bridge device 1030, the priority associated with the host data packet, and the ordering associated with the host data packet.

The downstream I3C bus controller 1008 is configured to receive the data elements generated by the unified adapter layer 1004 that are directed to the first downstream I3C bridge device 1016 or the second downstream I3C bridge device 1018. If a data element is a command data element or a payload data element, the downstream I3C bus controller 1008 is configured to packetize the data element in accordance with the I3C protocol to generate a device data packet for transmission to the one of the first downstream I3C bridge device 1016 or the second downstream I3C bridge device 1018 associated with the data element. If a data element is a bus controller parameter setting associated with a command data element and/or payload data element, the downstream I3C bus controller 1008 is configured to adjust one or more bus controller components in accordance with the bus controller parameter setting prior to transmission of the device data packets based on the associated data elements to the one of the first downstream I3C bridge device 1016 or the second downstream I3C bridge device 1018 associated with the data element in accordance with the I3C protocol.

The upstream I3C bus controller 1010 is configured to receive the data elements generated by the unified adapter layer 1004 that are directed to the first upstream I3C bridge device 1028 or the second upstream I3C bridge device 1030. If a data element is a command data element or a payload data element, the upstream I3C bus controller 1010 is configured to packetize the data element in accordance with the I3C protocol to generate a device data packet for transmission to the one of the first upstream I3C bridge device 1028 or the second upstream I3C bridge device 1030 associated with the data element. If a data element is a bus controller parameter setting associated with a command data element and/or payload data element, the upstream I3C bus controller 1010 is configured to adjust one or more bus controller components in accordance with the bus controller parameter setting prior to transmission of the device data packets based on the associated data elements to the one of the first upstream I3C bridge device 1028 or the second upstream I3C bridge device 1030 associated with the data element in accordance with the I3C protocol.

If the device data packet is transmitted to the first I3C downstream bridge device 1016, first I3C downstream bridge device 1016 is configured to determine whether the device data packet is directed to the first I3C device 1020 or the second I3C device 1022 and routes the device data packet accordingly. If the device data packet is transmitted to the second downstream I3C bridge device 1018, the second downstream I3C bridge device 1018 is configured to determine whether the device data packet is directed to the third I3C device 1024 or the fourth I3C device 1026 and routes the device data packet accordingly. If the device data packet is transmitted to the first I3C upstream bridge device 1028, first I3C upstream bridge device 1028 is configured to determine whether the device data packet is directed to the fifth I3C device 1032 or the sixth I3C device 1034 and routes the device data packet accordingly. If the device data packet is transmitted to the second upstream I3C bridge device 1030, the second upstream I3C bridge device 1030 is configured to determine whether the device data packet is directed to the seventh I3C device 1036 or the eighth I3C device 1038 and routes the device data packet accordingly.

The first I3C device 1020, the second I3C device 1022, the third I3C device 1024, and the fourth I3C device 1026 are configured to generate device data packets that are packetized in accordance with the I3C protocol. The first I3C device 1020 and the second I3C device 1022 are configured to transmit the device data packets to the first I3C downstream bridge device 1016. The first downstream I3C bridge device 1016 is configured to transmit the received device data packets to the downstream I3C bus controller 1008 in accordance with the I3C protocol. The third I3C device 1024 and the fourth I3C device 1026 are configured to transmit the device data packets to the second downstream I3C bridge device 1018. The second downstream I3C bridge device 1018 is configured to transmit the received device data packets to the downstream I3C bus controller 1008 in accordance with the I3C protocol

The fifth I3C device 1032, the sixth I3C device 1034, the seventh I3C device 1036, and the eighth I3C device 1038 are configured to generate device data packets that are packetized in accordance with the I3C protocol. The fifth I3C device 1032 and the sixth I3C device 1034 are configured to transmit the device data packets to the first upstream I3C bridge device 1028. The first upstream I3C bridge device 1028 is configured to transmit the received device data packets to the upstream I3C bus controller 1010 in accordance with the I3C protocol. The seventh I3C device 1036 and the eighth I3C device 1038 are configured to transmit the device data packets to the second upstream I3C bridge device 1030. The second upstream I3C bridge device 1030 is configured to transmit the received device data packets to the upstream I3C bus controller 1010 in accordance with the I3C protocol

The unified adapter layer 1004 is configured to decode the received device data packets that are packetized in accordance with the I3C protocol. In an embodiment, the unified adapter layer 1004 is configured to determine the priority associated with each device data packet. The unified adapter layer 1004 is configured to generate one or more data elements based on each of the received device data packets and associate each of the data elements based of a device data packet with the priority associated with that device data packet.

The A-PHY bus controller 1006 is configured to receive data elements generated by the unified adapter layer 1004 and packetize the data elements in accordance with the A-PHY protocol to generate host data packets for transmission to the host device 1012. The A-PHY bus controller 1006 is configured to transmit the generated host data packets based on the priority associated with the data elements used to generate the host data packets. In an embodiment, the unified adapter layer 1004 to configured to determine the priority associated with each of the device data packets based on a priority associated with the device 1016, 1018, 1028, 1030 that transmitted the device data packet. In an embodiment, the unified adapter layer 1004 prioritizes device data packets received from a device 1016, 1018, 1028, 1030 that generates an interrupt over device data packets received from the other devices 1016, 1018, 1028, 1030.

An example of an upstream I3C device is a sensor unit device. An example of a downstream I3C device is a display unit device. In an embodiment, the host device 1012 supplies power to the sensor unit device and to the display unit device. In an embodiment, the host device 1012 receives high speed uni-directional sensor data from the sensor unit device and the transmits high speed uni-directional display data to the display unit device. In an embodiment, the host device 1012 exchanges bi-directional command and control data with the sensor unit device and the display unit device.

The system 1000 illustrates usage of an asymmetric A-PHY network. The Bridge Adaption layer can either be “upstream” or “downstream” of A-PHY Host. Simple mapping of A-Packets for HCl register access (read/write) enable the Bi-Directional Low Speed stream. The use of A-PHY network efficiently (per use case) may allow for traffic prioritization (as necessary, and when possible). The scale may accommodate multiple use cases for example for camera, sensors, audio, and video. Upstream flow may use the asymmetry of A-PHY network and prioritize in-band interrupts and read transfers. In-band interrupts with data may use uni-directional high-speed stream. Transfer commands with data may use bi-directional low speed stream. Transfer responses with data may use either data stream (selectable per transfer). Downstream flow may use the asymmetry of A-PHY Network and prioritize write transfers and broadcast CCCs. In-band interrupts with data may use bi-directional low speed stream. Transfer commands with data may use either data stream (selectable per transfer). Transfer responses with data may use bi-directional low Speed stream. The interface to upstream and downstream bridges may be independent. I3C transactions on one I3C bus that is not visible on the other I3C bus. FIG. 10 may not imply a “tunnel” or “pipe” between the two I3C buses, where each A-PHY to I3C bridge monitors incoming I3C transactions and forwards them to the A-PHY host with the expectation that such I3C transactions will be echoed or re-played on any other I3C buses via other such bridges on the A-PHY network.

The use of an embodiment of a bridge including a unified adapter layer may provide standardized and unified access from high level content protocol to A-PHY for interfacing with various devices running on different protocols such as for example, including but not limited to, CSI, DSI, I3C, and I3S. The use of an embodiment of a bridge including a unified adapter layer may be useful to isolate high speed bus and low speed bus and as well as enable sensing devices for automotive applications through leveraging the asymmetrical nature of the A-PHY protocol. The use of an embodiment of a bridge including a unified adapter layer may provide a simplified platform solution without the use of multiple bridges. The bridge may act as a network translation stack layer between A-packets and host controller interface (HCl) involving, for example, I3C transfers, HCl register read and write operations. Transferred commands may be fully enqueued/buffered and may avoid waiting for individual A-Packets (i.e. I²C, PAL, single byte or multi-byte packets). The implementation may be scalable to enable “streaming” of A-Packets during an I3C transfer command

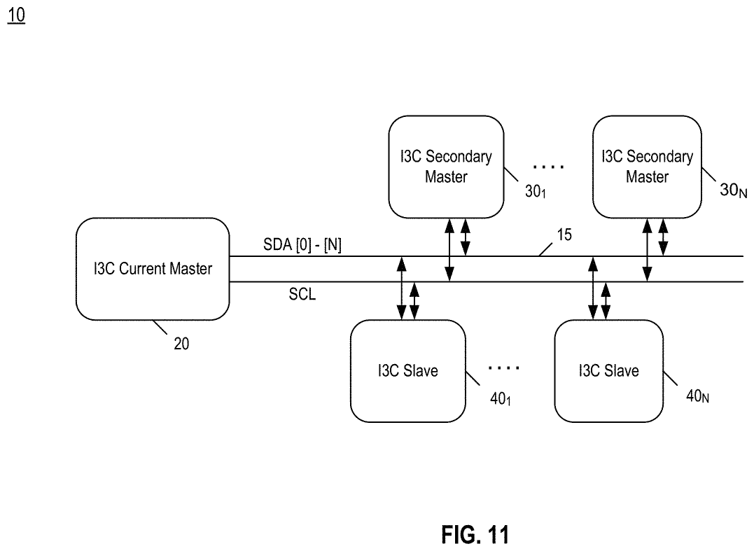

Referring now to FIG. 11, shown is a block diagram of a system 10 in accordance with an embodiment. More specifically, system 10 shown in FIG. 11 represents at least a portion of any one of a variety of different types of computing devices. In different embodiments, such computing devices can range from relatively small low power devices such as a smartphone, tablet computer, wearable device or so forth, to larger devices such as laptop or desktop computers, server computers, automotive infotainment devices and so forth. In any case, system 10 includes a bus 15, which may take the form of any medium of communication including printed circuit board, flex cable or other communication media. In embodiments herein, bus 15 may be implemented as an I3C bus in accordance with an I3C specification, available from the MIPI Alliance, Inc., Inter-Integrated Circuit (I²C) bus according to an I²C specification available from NXP Semiconductors or another half duplex communication interconnect that may be implemented with a minimal set of wires (e.g., two). Understand that as used herein, the term “IxC” is intended to refer to any and all variations of half-duplex links that may implement an embodiment, such as I²C or I3C interconnects. However, understand the scope is not limited in this regard and in other embodiments, bus 15 may be implemented as any type of multi-drop interconnect.

As illustrated, a current master device 20 couples to bus 15. While in some cases, current master device 20 may be a primary master, for purposes of discussion herein, any bus master-capable device may be the current master. In various embodiments, master device 20 may be implemented as a host controller that includes hardware logic to act as a bus master for bus 15. Master device 20 may include a controller (not shown in the high level view of FIG. 11) to control data (SDA[0]-[n]) and clock (SCL), as well as use (e.g.,) internal current sources or passive pullups to hold bus 15 when all coupled devices are powered off. In some cases, master device 20 may be a relatively simple host controller for a low complexity bus or other multi-drop bus, such as in accordance with an I²C or I3C specification. Other multi-drop interfaces such as Serial Peripheral Interface and/or Microwire also may be present in a particular embodiment. While in FIG. 11, bus 15 has multiple data lines, embodiments may also be used in connection with a bus having a single data line and a single clock line.

In different implementations, master device 20 may be an interface circuit of a multicore processor or other system on chip (SoC), application processor or so forth. In other cases, master device 20 may be a standalone host controller (such as a given integrated circuit (IC)) or main master device for bus 15. And of course other implementations are possible. In other cases, master device 20 may be implemented as hardware, software, and/or firmware or combinations thereof, such as dedicated hardware logic, e.g., a programmable logic, to perform bus master activities for bus 15.

Note that bus 15 is implemented as a multi-wire bus in which one or more serial lines form a data interconnect and a single serial line forms a clock interconnect. As such, in the general case data communications can occur, e.g., in bidirectional manner between masters and slaves and clock communication can occur from master to slaves. Master device 20 may be a relatively compute complex device (as compared to other devices on bus 15) that consumes higher power than other devices coupled to bus 15.

As shown in FIG. 11, multiple secondary master devices 30₁-30_{N} are present. In various embodiments, secondary master devices 30 (generically) may be implemented as dedicated master or bridge devices such as standalone IC's coupled to bus 15. In other cases, these devices may be independent logic functionality of a SoC or other processor (and in some cases may be implemented in the same IC as master device 20 known as a secondary master). One or more such secondary master devices 30 may be controlled to act as bus master for bus 15 while master device 20 is in a low power state, to enable bus operations to continue to proceed while in this low power state, based on a role definition in which as current master it drives a clock signal. Only one master can be the active master at a time. When one is the master, the others are acting as slaves.

As further illustrated in FIG. 11, a plurality of slave devices 40₁-40_{N} also couple to bus 15. In different embodiments, slave devices 40 (generically) may take many different forms. For purposes of discussion herein, it may be assumed that slave devices 40 may be always on (AON) devices, such as sensors like micro-electrical mechanical systems (MEMS), imaging sensors, peer-to-peer devices, debug devices or so forth. In embodiments, at least certain slave devices 40 may be configured to operate in a peer-to-peer (P2P) communication mode in which a given slave device 40 can receive P2P communication permission from master device 20 to issue P2P transactions to one or more other slave devices 40 (and/or one or more secondary master devices 30). Such P2P transactions may be used to effect intra-device transactions in certain implementations. In these instances, the initiating slave device 40 may be configured with, at least, clock control circuitry such that it may generate and provide the clock signal during such P2P communications. Understand that such P2P communications do not incur the overhead and complexity of a bus master role transfer. Instead, the slave device is simply granted permission by master device 20 to perform one or more P2P communications in which it provides the clock signal, while master device 20 maintains the bus master role. And such slave devices 40 having capability for P2P communications may implement limited additional functionality as compared to secondary master devices 30. Understand while shown at this high level in the embodiment of FIG. 11, many variations and alternatives are possible.

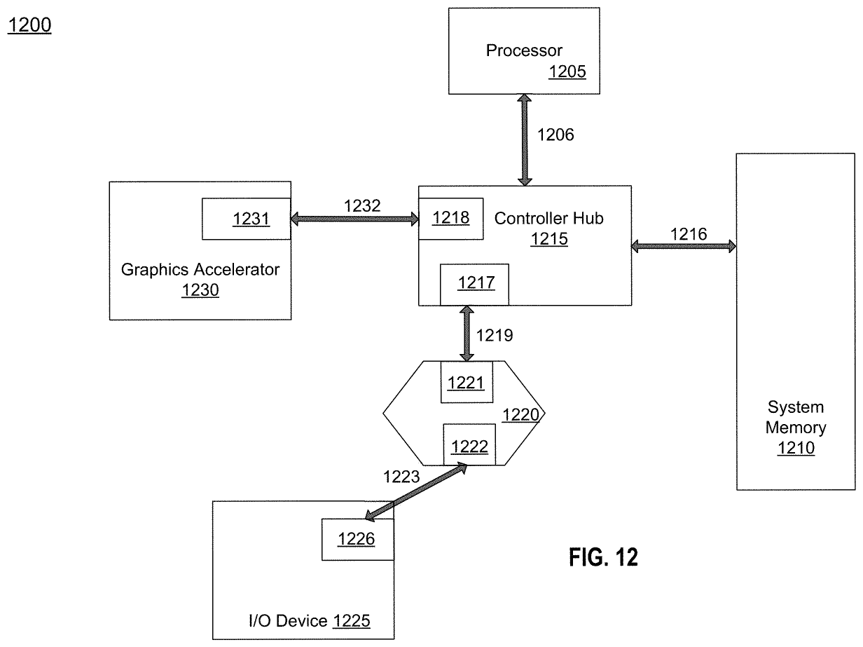

Embodiments may be implemented in a wide variety of interconnect structures. Referring to FIG. 12, an embodiment of a fabric composed of point-to-point links that interconnect a set of components is illustrated. System 1200 includes processor 1205 and system memory 1210 coupled to controller hub 1215. Processor 1205 includes any processing element, such as a microprocessor, a host processor, an embedded processor, a co-processor, or other processor. Processor 1205 is coupled to controller hub 1215 through front-side bus (FSB) 1206. In one embodiment, FSB 1206 is a serial point-to-point interconnect. In another embodiment, link 1206 includes a parallel serial, differential interconnect architecture that is compliant with different interconnect standards, and which may couple with one or more masters to control peer-to-peer communications on a bus as described herein.

System memory 1210 includes any memory device, such as random access memory (RAM), non-volatile (NV) memory, or other memory accessible by devices in system 1200. System memory 1210 is coupled to controller hub 1215 through memory interface 1216. Examples of a memory interface include a double-data rate (DDR) memory interface, a dual-channel DDR memory interface, and a dynamic RAM (DRAM) memory interface.

In one embodiment, controller hub 1215 is a root hub, root complex, or root controller in a PCIe interconnection hierarchy. Examples of controller hub 1215 include a chipset, a memory controller hub (MCH), a northbridge, an interconnect controller hub (ICH), a southbridge, and a root controller/hub. Often the term chipset refers to two physically separate controller hubs, i.e. a memory controller hub (MCH) coupled to an interconnect controller hub (ICH). Note that current systems often include the MCH integrated with processor 1205, while controller 1215 is to communicate with I/O devices, in a similar manner as described below. In some embodiments, peer-to-peer routing is optionally supported through root complex 1215.

Here, controller hub 1215 is coupled to switch/bridge 1220 through serial link 1219. Input/output modules 1217 and 1221, which may also be referred to as interfaces/ports 1217 and 1221, include/implement a layered protocol stack to provide communication between controller hub 1215 and switch 1220. In one embodiment, multiple devices are capable of being coupled to switch 1220.

Switch/bridge 1220 routes packets/messages from device 1225 upstream, i.e., up a hierarchy towards a root complex, to controller hub 1215 and downstream, i.e., down a hierarchy away from a root controller, from processor 1205 or system memory 1210 to device 1225. Switch 1220, in one embodiment, is referred to as a logical assembly of multiple virtual PCI-to-PCI bridge devices. Device 1225 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices and which may be coupled via an I3C bus, as an example. Often in the PCIe vernacular, such a device is referred to as an endpoint. Although not specifically shown, device 1225 may include a PCIe to PCI/PCI-X bridge to support legacy or other version PCI devices. Endpoint devices in PCIe are often classified as legacy, PCIe, or root complex integrated endpoints.

Graphics accelerator 1230 is also coupled to controller hub 1215 through serial link 1232. In one embodiment, graphics accelerator 1230 is coupled to an MCH, which is coupled to an ICH. Switch 1220, and accordingly I/O device 1225, is then coupled to the ICH. I/O modules 1231 and 1218 are also to implement a layered protocol stack to communicate between graphics accelerator 1230 and controller hub 1215. A graphics controller or the graphics accelerator 1230 itself may be integrated in processor 1205.

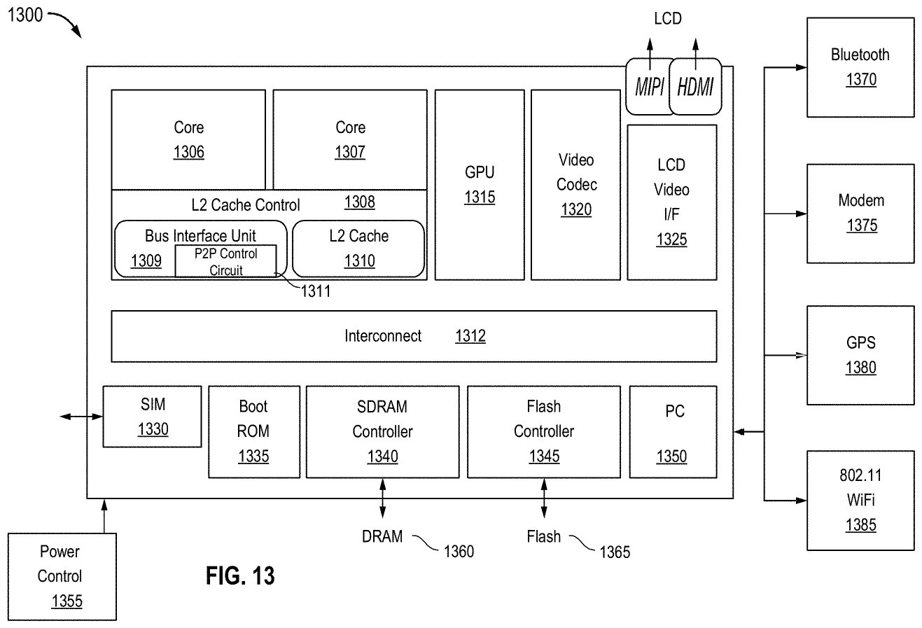

Turning next to FIG. 13, an embodiment of a SoC design in accordance with an embodiment is depicted. As a specific illustrative example, SoC 1300 may be configured for insertion in any type of computing device, ranging from portable device to server system. Here, SoC 1300 includes 2 cores 1306 and 1307. Cores 1306 and 1307 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1306 and 1307 are coupled to cache control 1308 that is associated with bus interface unit 1309 and L2 cache 1310 to communicate with other parts of system 1300 via an interconnect 1312. In the embodiment shown, bus interface unit 1309 includes a P2P control circuit 1311, which may be configured to enable P2P communications as described herein.

Interconnect 1312 provides communication channels to the other components, such as a Subscriber Identity Module (SIM) 1330 to interface with a SIM card, a boot ROM 1335 to hold boot code for execution by cores 1306 and 1307 to initialize and boot SoC 1300, a SDRAM controller 1340 to interface with external memory (e.g., DRAM 1360), a flash controller 1345 to interface with non-volatile memory (e.g., flash 1365), a peripheral controller 1350 (e.g., an eSPI interface) to interface with peripherals, video codecs 1320 and video interface 1325 to display and receive input (e.g., touch enabled input), GPU 1315 to perform graphics related computations, etc. Any of these interconnects/interfaces may incorporate aspects described herein, including control of intra-device communications. In addition, the system illustrates peripherals for communication, such as a Bluetooth module 1370, 3G modem 1375, GPS 1380, and WiFi 1385. Also included in the system is a power controller 1355.

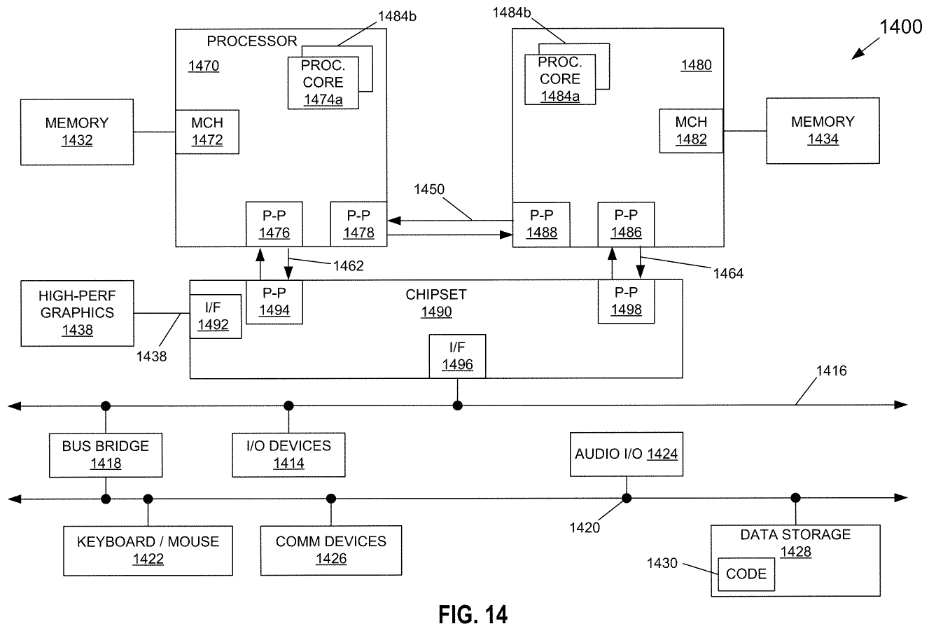

Referring now to FIG. 14, shown is a block diagram of a system in accordance with an embodiment. As shown in FIG. 14, multiprocessor system 1400 includes a first processor 1470 and a second processor 1480 coupled via a point-to-point interconnect 1450. As shown in FIG. 14, each of processors 1470 and 1480 may be many core processors including representative first and second processor cores (i.e., processor cores 1474a and 1474b and processor cores 1484a and 1484b).

Still referring to FIG. 14, first processor 1470 further includes a memory controller hub (MCH) 1472 and point-to-point (P-P) interfaces 1476 and 1478. Similarly, second processor 1480 includes a MCH 1482 and P-P interfaces 1486 and 1488. As shown in FIG. 14, MCH's 1472 and 1482 couple the processors to respective memories, namely a memory 1432 and a memory 1434, which may be portions of system memory (e.g., DRAM) locally attached to the respective processors. First processor 1470 and second processor 1480 may be coupled to a chipset 1490 via P-P interconnects 1462 and 1464, respectively. As shown in FIG. 14, chipset 1490 includes P-P interfaces 1494 and 1498.

Furthermore, chipset 1490 includes an interface 1492 to couple chipset 1490 with a high performance graphics engine 1438, by a P-P interconnect 1439. As shown in FIG. 14, various input/output (I/O) devices 1414 may be coupled to first bus 1416, along with a bus bridge 1418 which couples first bus 1416 to a second bus 1420. Various devices may be coupled to second bus 1420 including, for example, a keyboard/mouse 1422, communication devices 1426 and a data storage unit 1428 such as a disk drive or other mass storage device which may include code 1430, in one embodiment. Further, an audio I/O 1424 may be coupled to second bus 1420. Any of the devices shown in FIG. 14 may be configured to control intra-device communications between non-master devices in which one of the devices drives a clock signal for one or more of the interconnect structures, as described herein.

The following examples pertain to further embodiments.

In one example, an apparatus includes: a unified adapter layer to receive a first host data packet packetized in accordance with a host protocol and directed to a first device and decode the first host data packet to generate first and second data elements based on the first host data packet, the first device associated with a first device protocol; and a first bus controller coupled to the unified adapter layer and to be coupled to the first device via a first bus, the first bus controller to packetize the first data element in accordance with the first device protocol to generate a first device data packet for transmission to the first device in accordance with the first device protocol via the first bus and adjust a bus controller parameter base in part on the second data element.

In an example, the second data element is to define at least one of a clock speed setting of a bus controller clock of the first bus controller, a slew rate of the first bus controller, and a drive strength of the first bus controller.

In an example, the first data element includes one of a command data element and a payload data element.

In an example, the unified adapter layer is to receive a second host data packet packetized in accordance with the host protocol and associated with a second device and generate a third data element based on the second host data packet, the second device associated with a second device protocol; and a second bus controller coupled to the unified adapter layer and to be coupled to the second device via a second bus, the second bus controller to packetize the third data element in accordance with the second device protocol to generate a second device data packet for transmission to the second device via a second bus in accordance with the second device protocol.

In an example, the unified adapter layer is coupled to a configuration circuit and the unified adapter layer is to receive a third host data packet packetized in accordance with the host protocol and determine whether the third host data packet is associated with one of the first device and the second device based in part on configuration data associated with the first and second devices stored at a configuration circuit.

In an example, the unified adapter layer is to receive a third host data packet packetized in accordance with the host protocol and including a header including an adaption type and determine whether the third host data packet is associated with one of the first device and the second device based in part on the adaption type.

In an example, the unified adapter layer is to receive a third host data packet packetized in accordance with the host protocol and including a header including an adaption type and determine whether the third host data packet is associated with one of the first bus controller and the second bus controller based in part on the adaption type.

In an example, the first host data packet includes a header including a priority, the unified adapter layer is to associate the priority with the first data element, and the first bus controller is to transmit the first device data packet to the first device in accordance with the priority.

In an example, the first host data packet includes a header including an ordering, the unified adapter layer is to associate the ordering with the first data element, and the first bus controller is to transmit the first device data packet in accordance with the ordering.

In an example, the first host data packet includes a data header including error correction data and the unified adapter layer is to implement error correction associated with the first host data packet based in part on the error correction data.

In an example, the apparatus further includes a packet buffer coupled to the unified adapter layer and the first bus controller and the unified adapter layer is to place the first and second data elements in the packet buffer for processing by the first bus controller.

In an example, the first bus controller is to be coupled to a second device associated with the first device protocol via the first bus, the first device including a first bridge device to be coupled to at least one device and the second device including a second bridge device to be coupled at least one second bridge device.

In an example, the apparatus includes a second bus controller coupled to the unified adapter layer, the first bus controller to be coupled to at least the first device upstream of the apparatus and the second bus controller to be coupled to at least a second device downstream of the apparatus.

In an example, the unified adapter layer is to receive a plurality of related host data packets including the first host data packet prior to generation of data elements associated with each of the plurality of related host data packets.

In one example, a machine-readable medium comprising instructions stored thereon, which if performed by a machine, cause the machine to: receive a first device data packet packetized in accordance with a first device protocol from a first device at a first bus controller via a first bus in accordance with the first device protocol; receive a second device data packet packetized in accordance with a second device protocol from a second device at a second bus controller via a second bus in accordance with the second device protocol; generate a first data element based on the first device data packet and a second data element based on the second device data packet at a unified adapter layer; packetize the first data element in accordance with a host protocol associated with a host device to generate a first host data packet and packetize the second data element in accordance with the host protocol to generate a second host data packet; and transmit the first and second host data packets to the host device via a host device network in accordance with the host device protocol.

In an example, the machine-readable medium further includes instructions to cause the machine to: receive an interrupt from the first device; and prioritize transmission of the first host data packet over transmission of the second host data packet to the host device based in part on the received interrupt.

In an example, the machine-readable medium further includes instructions to cause the machine to packetize the first data element in accordance with the host protocol to generate the first host data packet and packetize the second data element in accordance with the host protocol to generate the second host data packet, wherein the host protocol comprises an Autonomous PHY (A-PHY) procotol.

In one example, a system includes: a host device associated with a host protocol; a first device associated with a first device protocol; a second device associated with a second device protocol; a bridge coupled to the host device, the bridge including: a unified adapter layer to: receive a first host data packet packetized in accordance with the host protocol and directed to the first device; generate a first data element based on the first host data packet; receive a second host data packet packetized in accordance with the host protocol and directed to the second device; and generate a second data element based on the second host data packet; a first bus controller coupled to the unified adapter layer and to be coupled to the first device via a first bus, the first bus controller to packetize the first data element in accordance with the first device protocol to generate a first device data packet for transmission to the first device via the first bus in accordance with the first device protocol; and a second bus controller coupled to the unified adapter layer and to be coupled to the second device via a second bus, the second bus controller to packetize the second data element in accordance with the second device protocol to generate a second device data packet for transmission to the second device via the second bus in accordance with the second device protocol.

In an example, the unified adapter layer is to decode the first host data packet to generate a third data element defining a bus controller parameter setting and the first bus controller is to adjust a bus controller parameter in accordance with the bus controller parameter setting.

In an example, the system is an automotive packet-based network transport system.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a unified adapter layer to receive a first host data packet packetized in accordance with a host protocol and directed to a first device and decode the first host data packet to generate first and second data elements based on the first host data packet, the first device associated with a first device protocol; and
a first bus controller coupled to the unified adapter layer and to be coupled to the first device via a first bus, the first bus controller to packetize the first data element in accordance with the first device protocol to generate a first device data packet for transmission to the first device in accordance with the first device protocol via the first bus and adjust a bus controller parameter base in part on the second data element.

2. The apparatus of claim 1, wherein the second data element is to define at least one of a clock speed setting of a bus controller clock of the first bus controller, a slew rate of the first bus controller, and a drive strength of the first bus controller.

3. The apparatus of claim 1, wherein the first data element comprises one of a command data element and a payload data element.

4. The apparatus of claim 1, wherein the unified adapter layer is to receive a second host data packet packetized in accordance with the host protocol and associated with a second device and generate a third data element based on the second host data packet, the second device associated with a second device protocol; and
a second bus controller coupled to the unified adapter layer and to be coupled to the second device via a second bus, the second bus controller to packetize the third data element in accordance with the second device protocol to generate a second device data packet for transmission to the second device via a second bus in accordance with the second device protocol.

5. The apparatus of claim 4, wherein the unified adapter layer is coupled to a configuration circuit and the unified adapter layer is to receive a third host data packet packetized in accordance with the host protocol and determine whether the third host data packet is associated with one of the first device and the second device based in part on configuration data associated with the first and second devices stored at a configuration circuit.

6. The apparatus of claim 4, wherein the unified adapter layer is to receive a third host data packet packetized in accordance with the host protocol and comprising a header including an adaption type and determine whether the third host data packet is associated with one of the first device and the second device based in part on the adaption type.

7. The apparatus of claim 4, wherein the unified adapter layer is to receive a third host data packet packetized in accordance with the host protocol and comprising a header including an adaption type and determine whether the third host data packet is associated with one of the first bus controller and the second bus controller based in part on the adaption type.

8. The apparatus of claim 1, wherein the first host data packet comprises a header including a priority, the unified adapter layer is to associate the priority with the first data element, and the first bus controller is to transmit the first device data packet to the first device in accordance with the priority.

9. The apparatus of claim 1, wherein the first host data packet comprises a header including an ordering, the unified adapter layer is to associate the ordering with the first data element, and the first bus controller is to transmit the first device data packet in accordance with the ordering.

10. The apparatus of claim 1, wherein the first host data packet comprises a data header including error correction data and the unified adapter layer is to implement error correction associated with the first host data packet based in part on the error correction data.

11. The apparatus of claim 1, wherein the apparatus further comprises a packet buffer coupled to the unified adapter layer and the first bus controller and the unified adapter layer is to place the first and second data elements in the packet buffer for processing by the first bus controller.

12. The apparatus of claim 1, wherein the first bus controller is to be coupled to a second device associated with the first device protocol via the first bus, the first device comprising a first bridge device to be coupled to at least one device and the second device comprising a second bridge device to be coupled at least one second bridge device.

13. The apparatus of claim 1, wherein the apparatus comprises a second bus controller coupled to the unified adapter layer, the first bus controller to be coupled to at least the first device upstream of the apparatus and the second bus controller to be coupled to at least a second device downstream of the apparatus.

14. The apparatus of claim 1, wherein the unified adapter layer is to receive a plurality of related host data packets including the first host data packet prior to generation of data elements associated with each of the plurality of related host data packets.

15. A machine-readable medium comprising instructions stored thereon, which if performed by a machine, cause the machine to:
receive a first device data packet packetized in accordance with a first device protocol from a first device at a first bus controller via a first bus in accordance with the first device protocol;
receive a second device data packet packetized in accordance with a second device protocol from a second device at a second bus controller via a second bus in accordance with the second device protocol;
generate a first data element based on the first device data packet and a second data element based on the second device data packet at a unified adapter layer;
packetize the first data element in accordance with a host protocol associated with a host device to generate a first host data packet and packetize the second data element in accordance with the host protocol to generate a second host data packet; and
transmit the first and second host data packets to the host device via a host device network in accordance with the host device protocol.

16. The machine-readable medium of claim 15, further comprising instructions to cause the machine to:
receive an interrupt from the first device; and
prioritize transmission of the first host data packet over transmission of the second host data packet to the host device based in part on the received interrupt.

17. The machine-readable medium of claim 15, further comprising instructions to cause the machine to packetize the first data element in accordance with the host protocol to generate the first host data packet and packetize the second data element in accordance with the host protocol to generate the second host data packet, wherein the host protocol comprises an Autonomous PHY (A-PHY) procotol.

18. A system comprising:
a host device associated with a host protocol;
a first device associated with a first device protocol;
a second device associated with a second device protocol;
a bridge coupled to the host device, the bridge comprising:
a unified adapter layer to:
receive a first host data packet packetized in accordance with the host protocol and directed to the first device;
generate a first data element based on the first host data packet;
receive a second host data packet packetized in accordance with the host protocol and directed to the second device; and
generate a second data element based on the second host data packet;
a first bus controller coupled to the unified adapter layer and to be coupled to the first device via a first bus, the first bus controller to packetize the first data element in accordance with the first device protocol to generate a first device data packet for transmission to the first device via the first bus in accordance with the first device protocol; and
a second bus controller coupled to the unified adapter layer and to be coupled to the second device via a second bus, the second bus controller to packetize the second data element in accordance with the second device protocol to generate a second device data packet for transmission to the second device via the second bus in accordance with the second device protocol.

19. The system of claim 18, wherein the unified adapter layer is to decode the first host data packet to generate a third data element defining a bus controller parameter setting and the first bus controller is to adjust a bus controller parameter in accordance with the bus controller parameter setting.

20. The system of claim 18, wherein the system comprises an automotive packet-based network transport system.
